(19) United States
(12) Patent Application Publication
(10) Pub. No.: US 2013/0328416 A1
(43) Pub. Date: Dec. 12, 2013

(54) Wireless Energy Sources for Integrated Circuits

(71) Applicants: Adam Whitworth, Mountain View, CA (US); Nilay Jani, San Jose, CA (US)

(72) Inventors: Adam Whitworth, Mountain View, CA (US); Nilay Jani, San Jose, CA (US)

(73) Assignee: Proteus Digital Health, Inc., Redwood City, CA (US)

(21) Appl. No.: 13/976,348

(22) PCT Filed: Dec. 23, 2011
(86) PCT No.: PCT/US11/67258

§ 371 Date: Aug. 12, 2013

Related U.S. Application Data
(60) Provisional application No. 61/428,055, filed on Dec. 29, 2010.

(51) Int. Cl. H02J 17/00

(52) U.S. Cl. CPC H02J 17/00
USPC 307/149

(57) ABSTRACT

A system comprising a control device and a wireless energy source electrically coupled to the control device is disclosed. The wireless energy source comprises an energy harvester to receive energy at an input thereof in one form and to convert the energy into a voltage potential difference to energize the control device. Also disclosed, is the system further comprising a partial power source. Also disclosed, is the system further comprising a power source.

### CROSS REFERENCE TO RELATED APPLICATIONS

Pursuant to 35 U.S.C. §119 (e), this application is a 371 application of International Patent Application No. PCT/US2011/067258 of the same title filed on Dec. 23, 2011 and published on Nov. 22, 2012 as International Patent Application Publication No. WO2012/092209, which is herein entirely incorporated by reference, which claims benefit to the filing date of U.S. Provisional Patent Application Ser. No. 61/428,055 entitled WIRELESS ENERGY SOURCES FOR INTEGRATED CIRCUITS filed Nov. 29, 2010, the disclosure of which applications is herein incorporated by reference.

### FIELD OF THE DISCLOSURE

The present disclosure is related generally to wireless energy sources for integrated circuits. More particularly, the present disclosure is related to wireless energy sources comprising energy harvesting and power management circuits for wireless power delivery to ingestible identifiers comprising an integrated circuit.

### INTRODUCTION

In the context of ingestible identifiers, such as an ingestible event marker (IEM), prescription medications are effective remedies for many patients when taken properly, e.g., according to instructions. Studies have shown, however, that on average, about 50% of patients do not comply with prescribed medication regimens. A low rate of compliance with medication regimens results in a large number of hospitalizations and admissions to nursing homes every year. In the United States alone, it has recently been estimated that the healthcare related costs resulting from patient non-compliance is reaching $100 billion annually.

Consequently, identifiers generally referred to as event markers have been developed, which may be incorporated into pharma-informatics enabled pharmaceutical compositions. These devices are ingestible and/or digestible or partially digestible. Ingestible devices include electronic circuitry for use in a variety of different medical applications, including both diagnostic and therapeutic applications. Some ingestible devices such as IEMs made by Proteus Biomedical, Inc., Redwood City, Calif., typically do not require an internal energy source for operation. The energy sources for these IEMs are activated upon association with a target site of a body by the presence of a predetermined specific stimulus at the target site, e.g., liquid (wetting), time, pH, ionic strength, conductivity, presence of biological molecules (e.g., specific proteins or enzymes that are present in the stomach, small intestine, colon), blood, temperature, specific auxiliary agents (e.g., foods ingredients such as fat, salt, or sugar, or other pharmaceuticals whose co-presence is clinically relevant), bacteria in the stomach, pressure, light. The predetermined specific stimulus is a known stimulus for which the controlled activation identifier is designed or configured to respond by activation.

A communication broadcasted by the energized ingestible identifier may be received by another device, e.g., a receiver, either inside or near the body, which may then record that the identifier, e.g., one that is associated with one or more active agents and pharmaceutical composition, has in fact reached the target site.

The digestibility or partial digestibility of the internal energy source and circuitry make it difficult to run diagnostic tests on the circuitry or other components without energizing the ingestible identifier and/or dissolving the device and thus deploying and/or destroying it prior to its ultimate end use. Therefore, it would be advantageous to provide a wireless energy source to energize ingestible identifier systems in a wireless mode and carry out diagnostic tests and verify operation, presence, and/or functionality of the ingestible identifier prior to its ultimate use.

### SUMMARY

In one aspect, a system comprises a control device and a wireless energy source electrically coupled to the control device. The wireless energy source comprises an energy harvester to receive energy at an input thereof in one form and to convert the energy into a voltage potential difference to energize the control device.

In another aspect, a system comprises a control device for altering conductance, a wireless energy source electrically coupled to the control device, and a partial power source. The wireless energy source comprises an energy harvester to receive energy at an input thereof in one form and to convert the energy into a first voltage potential difference to energize the control device. The partial power source comprises a first material electrically coupled to the control device and a second material electrically coupled to the control device and electrically isolated from the first material. The first and second materials are selected to provide a second voltage potential difference when in contact with a conducting liquid. The control device alters the conductance between the first and second materials such that the magnitude of the current flow is varied to encode information.

In yet another aspect, a system comprises a control device, a wireless energy source electrically coupled to the control device and a power source electrically coupled to the control device. The wireless energy source comprises an energy harvester to receive energy at an input thereof in one form and to convert the energy into a first voltage potential difference to energize the control device. The power source is electrically coupled to the control device and provides a second voltage potential difference to the control device.

### BRIEF DESCRIPTION OF THE FIGURES

FIG. 1 illustrates one aspect of a system comprising a wireless energy source and an identifier system for indicating the occurrence of an event.

FIG. 2 illustrates one aspect of a system comprising a wireless energy source, similar to the wireless energy source of FIG. 1, and an identifier system for indicating the occurrence of an event.

FIG. 3 illustrates one aspect of a system comprising a wireless energy source, similar to the wireless energy sources of FIGS. 1 and 2, and an identifier system for indicating the occurrence of an event.

FIG. 4 illustrates one aspect of a wireless energy source comprising an energy harvester and a power management circuit configured to harvest electromagnetic energy from the environment in the form of optical radiation.

FIG. 5 illustrates one aspect of a system that employs an energy harvesting technique based on optical radiation.

FIG. 6 illustrates one aspect of a system that employs an energy harvesting technique based on modulated optical radiation.

FIG. 7 is a schematic diagram of a vibration/motion system employed in vibration energy harvester described herein in connection with FIGS. 8-11.

FIG. 8 illustrates one aspect of a system comprising a wireless energy source that comprises an energy harvester comprising an electrostatic energy conversion element to convert vibration/motion energy into electrical energy as described in connection with FIG. 7.

FIG. 9 illustrates one aspect of a system comprising a wireless energy source that comprises an energy harvester comprising a piezoelectric energy conversion element to convert vibration/motion energy into electrical energy as described in connection with FIG. 7.

FIG. 10 is a schematic diagram of a piezoelectric type capacitor element of a wireless energy source that is configured to operate on the vibration/motion energy harvesting principle described in FIG. 7.

FIG. 11 illustrates one aspect of a system comprising a wireless energy source that comprises an energy harvester comprising an electromagnetic energy conversion element to convert vibration/motion energy into electrical energy as described in connection with FIG. 7.

FIG. 12 illustrates one aspect of a system comprising a wireless energy source that comprises an energy harvester comprising an acoustic energy conversion element.

FIG. 13 illustrates one aspect of a system comprising a wireless energy source comprising an energy harvester comprising a radio frequency energy conversion element.

FIG. 14 illustrates one aspect of a system comprising a wireless energy source comprising an energy harvester comprising a thermoelectric energy conversion element.

FIG. 15 illustrates one aspect of a system comprising a wireless energy source comprising an energy harvester comprising a thermoelectric energy conversion element similar to the element discussed in connection with FIG. 14.

FIG. 16 illustrates one aspect of an ingestible product that comprises a system for indicating the occurrence of an event inside the body.

FIG. 17A illustrates a pharmaceutical product shown with a system, such as an ingestible event marker or an ionic emission module, according to one aspect of the present disclosure.

FIG. 17B illustrates a pharmaceutical product, similar to the product of FIG. 17A, shown with a system, such as an ingestible event marker or an identifiable emission module, according to one aspect of the present disclosure.

FIG. 18 illustrates a more detailed diagram of one aspect of the systems of FIGS. 17A and 17B.

FIG. 19 illustrates one aspect of a system comprising a sensor and in contact with the conducting fluid.

FIG. 20 is a block diagram representation of a device described in connection with FIGS. 18 and 19, according to one aspect of the present disclosure.

FIG. 21 illustrates another aspect of the systems of FIGS. 17A and 17B, respectively, shown in more detail.

FIG. 22 illustrates one aspect of a system, similar to the system of FIG. 18, which includes a pH sensor module connected to a material, which is selected in accordance with the specific type of sensing function being performed.

FIG. 23 is a schematic diagram of a pharmaceutical product supply chain management system, according to one aspect of the present disclosure.

FIG. 24 is schematic diagram of a circuit according to various aspects of the present disclosure.

FIG. 25 is a functional block diagram of a demodulation circuit that performs coherent demodulation that may be present in a receiver, according to one aspect of the present disclosure.

FIG. 26 illustrates a functional block diagram for a beacon module within a receiver, according to one aspect of the present disclosure.

FIG. 27 is a block diagram of the different functional modules that may be present in a receiver, according to one aspect of the present disclosure.

FIG. 28 is a block diagram of a receiver, according to one aspect of the present disclosure.

FIG. 29 provides a block diagram of a high frequency signal chain in a receiver, according to one aspect of the present disclosure.

FIG. 30 provides a diagram of how a system that includes a signal receiver and an ingestible event marker may be employed, according to one aspect of the present disclosure.

### DETAILED DESCRIPTION

The present disclosure provides multiple aspects of systems comprising a wireless energy source for energizing identifiers to indicate the occurrence of an event. In addition, the system may include other energy sources and may be activated in multiple other modes as described below. In one aspect, the wireless energy source may be activated in a wireless mode by an external source. In another aspect, in addition, the system may be activated in a galvanic mode by a chemical reaction by exposing the system to a conducting fluid.

In the wireless activation mode, the identifier system may be activated by a stimulus from an external and/or an internal source for example, an Implantable Pulse Generator (IPG). The stimulus provides energy that can be harvested by the wireless energy source. The external stimulus may be provided by electromagnetic radiation in the form of light or radio frequency (RF), vibration, motion, and/or thermal sources. In response to the stimulus, the system is energized and generates a signal that can be detected by external and/or internal devices in order to communicate information associated with the system to such devices. In one aspect, the system is operative to communicate information that can be used to conduct diagnostic tests on, verify operation of, detect presence of, and/or determine the functionality of the system. In other aspects, the system is operative to communicate a unique current signature associated with the system.

In the galvanic activation mode, the system is activated when it comes into contact with a conducting fluid. In the instance where the system is used with a product intended to be ingested by a living organism, upon ingestion, the system comes into contact with a conducting body fluid and is activated. In one aspect, the system includes dissimilar materials positioned on a framework such that when a conducting fluid comes into contact with the dissimilar materials, a voltage potential difference is created. The voltage potential difference, and hence the voltage, is used to energize or power up control logic that is positioned within the framework. The potential difference causes ions or current to flow from the first dissimilar material to the second dissimilar material via the control logic and then through the conducting fluid to complete a circuit. The control logic is operative to control the conductance between the two dissimilar materials and, hence, controls or modulates the conductance. In addition, the control logic is capable of encoding information on a current signature.

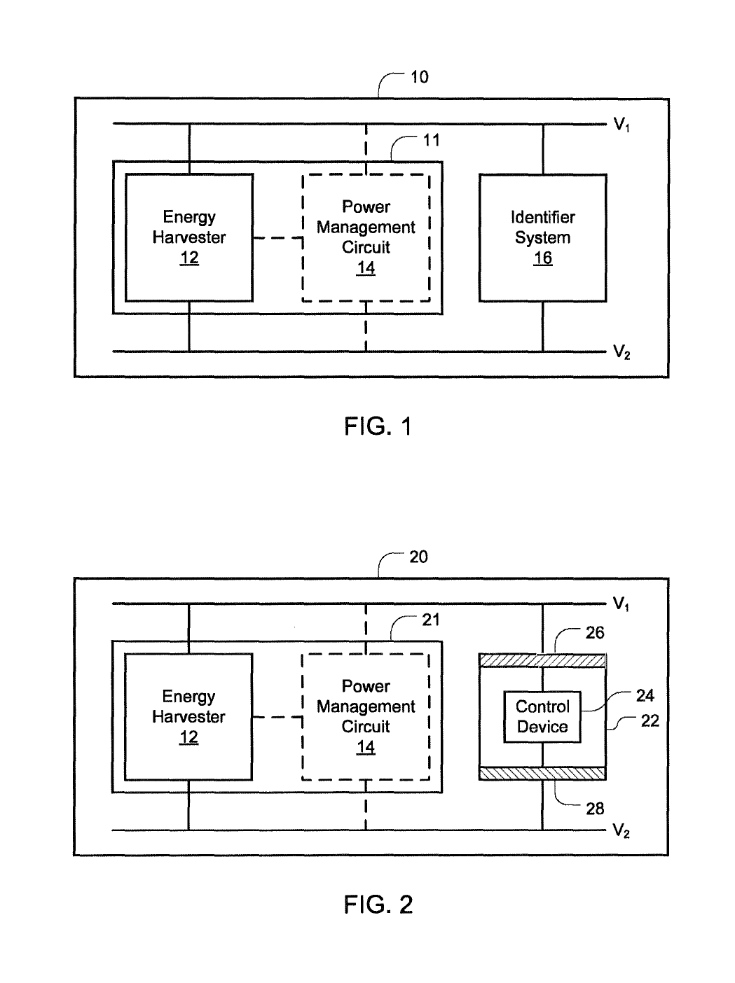

FIG. 1 illustrates one aspect of a system 10 comprising a wireless energy source 11 and an identifier system 16 comprising a control device for indicating the occurrence of an event. The wireless energy source 11 energizes the control device in a wireless mode. The wireless energy source 11 comprises an energy harvester 12 to convert energy in one form received at an input thereof to energy in another form at an output thereof. In various aspects, the output energy is in the form of a voltage potential difference. Optionally, the wireless energy source may comprise a power management circuit 14 (shown in phantom to indicate that it is optional) for providing energy suitable to operate the circuits of the identifier system 16. In one aspect, the system 10 may be a tag, such as an electronic label associated with an article for the purpose of identifying the article, for example. The system 10 can be used in a variety of different applications, including as a component of an ingestible identifier, such as an IEM, e.g., pharma-informatics enabled pharmaceutical composition. In one aspect, the identifier system 16 comprises an in-body device that is operative when energized to communicate information to an external system located outside the body. In one aspect, the in-body device is operative to communicate information outside the body only when the wireless energy source is energized by an external energy source located outside the body.

In the most general aspect referenced in FIG. 1, the system 10 could do away with a standalone internal energy source, such as a partial power supply (described hereinbelow), battery, or supercapacitor, for example, and is powered solely by a voltage potential (V₁-V₂) generated by the wireless energy source 11 from the energy collected by the energy harvester 12 as disclosed herein.

In various aspects, described in more detail below, the energy harvester 12 collects energy from the environment using a variety of techniques including, but not limited to, electromagnetic radiation (e.g., light or RF radiation), vibrations/motion, acoustic waves, thermal, etc. Such techniques may be implemented using a variety of technologies, such as, for example, micro-electro mechanical systems (MEMS), electromagnetic, piezoelectric, thermoelectric (e.g., Seebeck or Peltier effects), among others. The energy harvester 12 may be optimized to accommodate the particular energy harvesting technique implemented by the system 10.

In some aspects, the input to the energy harvester 12 can be driven or stimulated directly by a dedicated source to produce direct current power source, such as a battery in the form of a voltage potential suitable to operate the circuits of the identifier system 16 at the output of the energy harvester 12. In such aspects, the power management circuit 14 may be eliminated. In other aspects, when the voltage potential developed by the energy harvester 12 is not suitable to operate the circuits of the identifier system 16, the power management circuit 14 may employed to provide a voltage potential that is suitable for powering the circuits of the identifier system 16. The power management circuit 14 can adapt its input to the energy harvester 12 implemented by the system 10 and its output to the load, e.g., the identifier system 16. In various aspects, the power management circuit 14 may comprise some form of converter to convert the input voltage generated by the energy harvester 12 to a voltage potential suitable for operating the identifier system 16. Although the converter may be implemented in different configurations, DC-DC converters, charge pumps, boost converters, and rectifying AC-DC converters may be adapted for use in the power management circuit 14. Additionally, the power management circuit 14 may comprise voltage regulator, buffer, and control circuits, among others.

In one aspect, either the system 10 and/or the identifier system 16 may be fabricated on an integrated circuit (IC). In certain aspects, the identifier system 16 may comprise an on-board random access memory (RAM). The identifier system 16 comprises control logic that is operative to modulate the voltage on a capacitor plate located on a top surface of the IC with respect to the substrate voltage of the IC to modulate the information to be communicated. The modulated voltage can be detected by a capacitively coupled reader (not shown). Accordingly, when the wireless energy source 11 is activated by an external source, the identifier system 16 is operative to communicate information associated with the system 10. The information may be employed to functionally test and perform diagnostic tests on the system 10 as well as verify the operation of and detect the presence of the system 10. In other aspects, the identifier system 16 is operative to communicate a unique signature associated with the system 10.

Although described generally herein in terms of voltage potential, the scope of the disclosed systems is not so limited. In that regard, where the operation of the circuits of the identifier system 16 depend on the delivery of a predetermined current rather than a predetermined voltage potential, the energy harvester 12 and/or power management circuit 14 may be designed and implemented to operate accordingly.

FIG. 2 illustrates one aspect of a system 20 comprising a wireless energy source 21, similar to the wireless energy source 11 of FIG. 1, and an identifier system 22 for indicating the occurrence of an event. The wireless energy source 21 energizes the control device in a wireless mode. The wireless energy source 21 comprises the energy harvester 12 to convert energy in one form received at an input thereof to energy in another form at an output thereof. In various aspects, the output energy is in the form of a voltage potential difference. Optionally, the wireless energy source may comprise the power management circuit 14 (shown in phantom to indicate that it is optional) for providing energy suitable to operate the circuits of the identifier system 22. In the referenced aspect, the system 20 comprises a hybrid energy source comprising the wireless energy source 11 and a partial power source in the identifier system 22. The wireless energy source 11 is electrically coupled to a control device 24 to supply power to the circuits of the identifier system 22 separately from the partial power source. In one aspect, the partial power source can be activated in galvanic mode when it comes into contact with a conductive fluid, which may comprise a conductive liquid, gas, mist, or any combination thereof. The wireless energy source 11 and the partial power source may be activated either individually or in combination. Accordingly, the system 20 may be operated in a wireless mode, a galvanic mode, or combinations thereof. The system 20 can be used in a variety of different applications, including as a component of an ingestible identifier, such as an IEM, e.g., pharma-informatics enabled pharmaceutical composition.

The identifier system 22 comprises the control device 24 for altering conductance and a partial power source comprising a first conductive material 26 electrically coupled to the control device 24 and a second conductive material 28 electrically coupled to the control device and electrically isolated from the first material 26. The first and second conductive materials 26, 28 are selected to provide a voltage potential difference when in contact with a conducting fluid. The control device 24 alters the conductance between the first and second conductive materials 26, 28 such that the magnitude of the current flow is varied to encode information. As discussed in reference to FIG. 1, optionally the power management circuit 14 may be employed to adapt its input to the energy harvester 12 and its output to the load, e.g., the identifier system 22. The control device 24 comprises control logic that is operative in either wireless or galvanic modes to modulate the voltage on the first and second conductive materials 26, 28 to communicate information. The modulated voltage can be detected by respective first and second capacitively coupled plates of a reader positioned externally of the system 20. In one aspect, the system 20 may comprise additional capacitive plates formed of similar or dissimilar conductive materials operative to communicate information associated with the system 20.

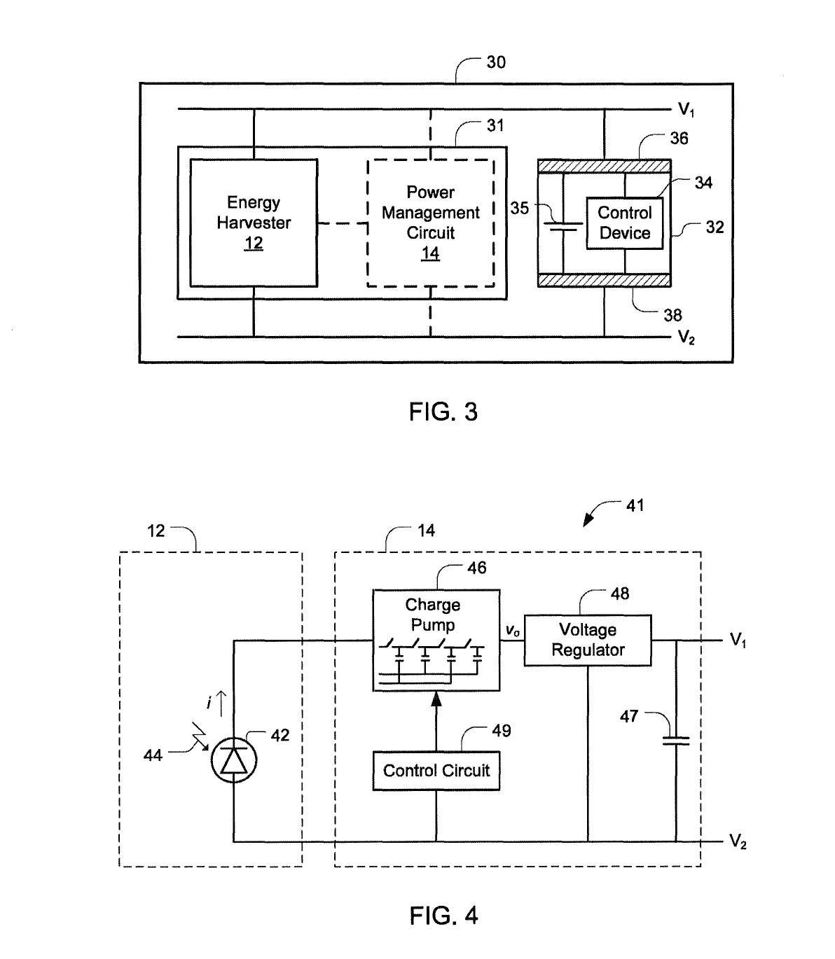

FIG. 3 illustrates one aspect of a system 30 comprising a wireless energy source 31, similar to the wireless energy sources 11, 21 of FIGS. 1 and 2, and an identifier system 32 for indicating the occurrence of an event. The wireless energy source 31 energizes the control device in a wireless mode. The wireless energy source 31 comprises the energy harvester 12 to convert energy in one form received at an input thereof to energy in another form at an output thereof. In various aspects, the output energy is in the form of a voltage potential difference. Optionally, the wireless energy source may comprise the power management circuit 14 (shown in phantom to indicate that it is optional) for providing energy suitable to operate the circuits of the identifier system 32. The system 30 can be used in a variety of different applications, including as a component of an ingestible identifier, such as an IEM, e.g., pharma-informatics enabled pharmaceutical composition.

In the referenced aspect, the system 30 comprises a hybrid energy source comprising the wireless energy source 31 and an on-board power source 35 such as a micro-battery or supercapacitor. The wireless energy source 31 is coupled to the on-board power source 35 and can be employed to power the identifier system 30 in the wireless mode. In one aspect, the micro-battery may be a thin film integrated battery fabricated directly in IC packages in any shape or size. In another aspect, a thin-film rechargeable battery or a supercapacitor may be designed and implemented to bridge the gap between a battery and a conventional capacitor. In design implementations incorporating a rechargeable thin-film micro-battery or supercapacitor, the wireless energy source 31 may be employed for charging or recharging the battery or supercapacitor. Thus, the wireless energy source 31 can be employed to minimize energy drain of the on-board power source 35.

The identifier system 32 comprises a control device 34 for altering conductance and a partial power source comprising a first capacitive plate 36 electrically coupled to the control device 34 and a second capacitive plate 38 electrically coupled to the control device and electrically isolated from the first capacitive plate 36. The control device 34 alters the conductance between the first and second capacitive plates 36, 38 such that the magnitude of the current flow is varied to encode information. The wireless energy source 31 is coupled to the control device 34 to supply power to the circuits of identifier system 32 separately from or in conjunction with the on-board power source 35. As discussed in reference to FIGS. 1 and 2, optionally the input of the power management circuit 14 may be adapted to the output of the energy harvester 12 and the output of the power management circuit 14 may be adapted to the load, e.g., the identifier system 32. The control device 34 comprises control logic that is operative to modulate a voltage on the first and second conductive plates 36, 38 to modulate the information to be communicated. The voltage modulated onto the first and second conductive plates 36, 38 can be detected by respective first and second capacitively coupled plates of a reader. The first and second capacitive plates 36, 38 may be formed of similar or dissimilar materials.

In the aspects referenced in FIGS. 1-3, the power management circuit 14 is shown in phantom to indicate that it may be optional. The power management circuit 14 may be employed to regulate, boost, or condition the energy collected by the energy harvester 12 to provide a direct current power source, such as a battery, in the form of a voltage potential suitable for operating the circuits of the systems 16, 22, 32. It will be appreciated that any of the components or elements of the systems 16, 22, 32 can be used alone or in combination with other systems within the scope of the present disclosure.

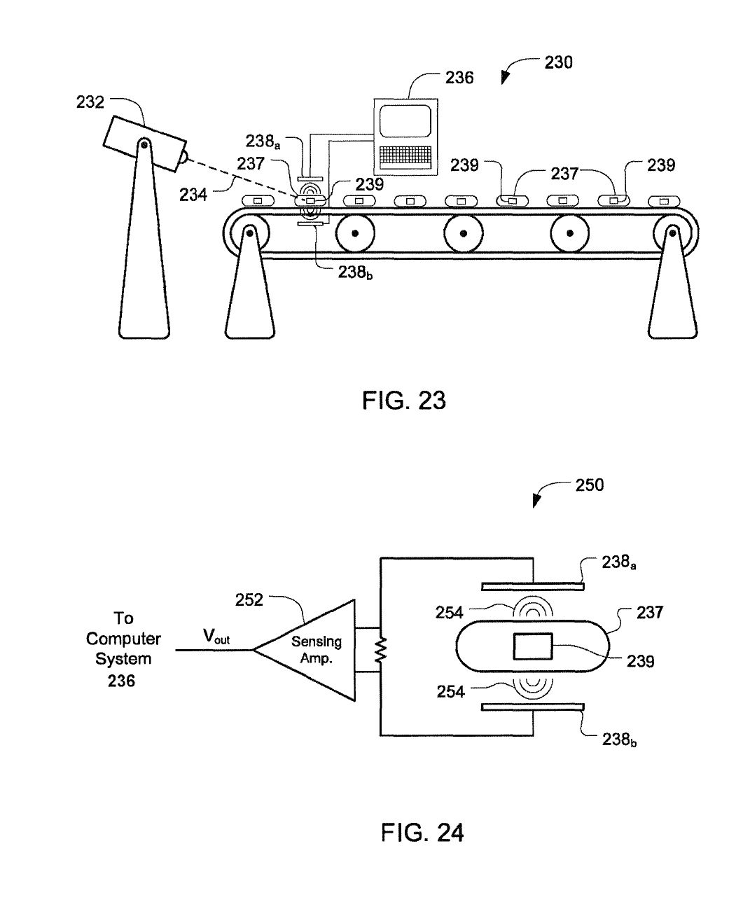

In the various aspects of the systems 10, 20, 30 described in connection with FIGS. 1-3, the energy harvester 12, power management circuit 14, and circuits of the identifier systems 16, 22, 32 can be integrated in one or multiple ICs. In operation, when activated in either in wireless or galvanic mode, the systems 10, 20, 30 are operable to indicate the occurrence of an event. Although different modes of communication may be employed, the information communicated may be the same. In the wireless mode, the information may be communicated as a series of pulses at a rate of 10-20 Hz and may be phase modulated at 1 kHz. The information may be encoded using a variety of techniques such as Binary Phase-Shift Keying (BPSK), Frequency Modulation (FM), Amplitude Modulation (AM), On-Off Keying, and PSK with On-Off keying. In certain aspects, the systems 10, 20, 30 and/or identifier systems 16, 22, 32 may comprise an on-board RAM. The information may comprise identification number, information contained in the on-board RAM such as medication, date code, and manufacturing date. In one aspect, the information may be communicated by modulating a voltage on a plate formed on a top surface of the IC with respect to the substrate voltage of the IC. A capacitively coupled reader can be used to detect the modulated voltage (shown in FIGS. 23, 24, for example).

Furthermore, any of the identifier systems 16, 22, 32 described in connection with respective FIGS. 1-3 can be implemented to include an in-body device such as an IEM that can be energized in multiple modes and communicate information outside the body using multiple techniques. By way of example and not limitation, in one aspect the IEM may be energized by deriving external (outside the body) potentials and internal (inside the body) potentials at different points in time and responding to such external and internal potentials by communicating to at least one external device located inside or partially inside or outside the body. In another aspect, the IEM may derive different levels of potentials through external and internal energizing elements (e.g., energy harvester comprising a wireless energy source, an internal galvanic energy system, a micro-battery, or supercapacitor) and communicating to an external device in response to such derived different levels of potentials. In another aspect, the IEM may derive energy from an external source and store the derived energy in a capacitor or supercapacitor, for example, where the IEM can employ the stored energy for communicating to an external device after a delay. In yet another aspect, the IEM can be energized by external or internal sources at different locations within the body such as, for example, esophagus, stomach, lower part of the intestine, colon, and so forth. In another aspect, the IEM may employ external and internal energy selectively to communicate to different external devices at different points in time. In various aspects, the IEM may communicate with different external devices e.g., a patch or other receivers placed in watches, necklaces or external locations. Examples of external devices that the IEM may communicate with are described in commonly assigned U.S. Patent Application Publication No. 2010/0312188 (Ser. No. 12/673,326) filed Dec. 15, 2009 and entitled “Body-Associated Receiver and Method,” which was issued Feb. 14, 2012 as U.S. Pat. No. 8,114,021, U.S. Patent Application Publication Number 2008/0284599 (Ser. No. 11/912,475) filed Apr. 28, 2006 entitled “Pharma-Informatics System,” and U.S. Patent Application Publication Number 2009/0227204 (Ser. No. 12/404,184) filed Mar. 13, 2009 entitled “Pharma-Informatics System,” where the disclosure of each is incorporated herein by reference in its entirety. In yet another aspect, the IEM may only receive a control command for its activation from any external and/or internal device while the IEM is energized by any of the modes discussed above.

FIG. 4 illustrates one aspect of a wireless energy source 41 comprising an energy harvester 12 and a power management circuit 14 configured to harvest electromagnetic energy from the environment in the form of optical radiation. The energy harvester 12 comprises an optical energy conversion element such as a photodiode 42 configured to convert incoming radiant electromagnetic energy in the form of light 44 photons into electrical energy. The particular photodiode 42 may be selected to optimally respond to the wavelength of the incoming light 44, which can range from the visible spectrum to the invisible spectrum. As used herein the term radiant electromagnetic energy refers to light in the visible or invisible spectrum ranging from the ultraviolet to the infrared frequency range.

As shown in FIG. 4, as light 44 strikes the P-N junction of the photodiode 42, either a current or voltage is generated by the photodiode 42 depending on the mode of operation. In the referenced aspect, the photodiode 42 is reverse biased and a current i proportional to the amount of the light 44 striking the photodiode 42 flows from the photodiode 42 into a charge pump 46 circuit. The charge pump 46 may be implemented in a variety of configurations. Essentially, a charge pump is a type of DC-DC converter that uses capacitors as energy storage elements to create a higher (boost) voltage power source. The charge pump 46 circuits are relatively simple and are capable of high efficiencies—as high as 90-95%, making them attractive solutions for voltage boosting applications.

The charge pump 46 uses some form of switching device(s) to control the connection of voltages to the capacitors. To generate a higher voltage, a first stage involves connecting a capacitor across a voltage to charge it up. In a second stage, the capacitor is disconnected from the original charging voltage and reconnected with its negative terminal to the original positive charging voltage. Because the capacitor retains the voltage stored across it (ignoring leakage effects) the positive terminal voltage is added to the original, effectively doubling the voltage. The pulsing nature of the higher voltage output can be typically smoothed by the use of an output capacitor. Accordingly, the charge pump 46 converts the current i generated by the photodiode 42 into an output voltage vₒ. The charge pump 46 may have any suitable number of stages to boost the input voltage to any suitable level. A control circuit 49 controls the operation of the switching device(s) to coordinate the connection of voltages to the capacitors of the charge pump 46 to generate an output voltage vₒ suitable to operate the circuits of the identifier systems 16, 22, 32 of FIGS. 1-3.

DC-DC converters can be either boost converters or charge pumps. For high efficiency, most conventional DC-DC converters employ an external inductor. Because large value inductors with many windings are difficult to fabricate using a monolithic or planar micro-fabrication process, charge pumps are more readily suited in integrated circuit implementations because capacitors are used rather than inductors. This enables efficient DC-DC conversion. There exist many alternative configurations for DC-DC converters using switching capacitors. Such DC-DC converters include, without limitation, voltage doublers, the Dickson charge pump, the ring converter, and the Fibonacci converter, among others.

A voltage regulator 48 may optionally be coupled to the charge pump 46. The voltage regulator regulates the output voltage vₒ of the charge pump 46 and produces a regulated output voltage V₁ relative to a substrate voltage V₂. The voltage potential (V₁-V₂) is suitable to operate the circuits of any of the systems 16, 22, 32 of FIGS. 1-3. In various aspects, the charge pump 46 may be replaced with any suitable voltage boosting circuit such as boost regulator, flyback, step-up (boost), or forward converter. In other aspects, the charge pump 46 may be replaced with a DC-DC converter type voltage boosting circuit.

In one aspect, the photodiode 42 may be a conventional photodiode, PIN photodiode, or Complementary Metal Oxide Semiconductor (CMOS) PN diode. The photodiode may be a monolithic integrated circuit element fabricated using semiconductor materials such as Silicon (Si), Silicon Nitride (SiNi), Indium Gallium Arsenide (InGaAs), among other semiconductor materials. Although shown as a single component, the photodiode 42 may comprise a plurality of photodiodes connected in series and/or in parallel depending on the particular design and implementation. In various aspects, the photodiode 42 may be implemented with diodes or phototransistors. In other aspects, the photodiode 42 may be replaced with a photovoltaic cell that generates a voltage proportional to the incident light 44 striking a surface thereof. The charge pump 46 circuit may be employed to boost the voltage output of the photovoltaic cell to a level suitable for operating the circuits of the identifier system 12, 22, 32.

In various aspects, the photodiode 42 may be integrated with the IC portions of the systems 10, 20, 30, layered on the surface of the IC, or coated into a skirt or a current path extender portion of the IC. A light aperture may be formed on the system 10, 20, 30 IC to allow the incident light 44 to strike the P-N junction of the photodiode 42. A MEMS process may used to shield other areas of the system 10, 20, 30 from the incident light 44.

Where the underlying energy harvester 12 technology employs light radiation techniques, a light source having a predetermined spectral composition and illumination level may be used to generate a light beam to strike the photodiode 42 element of the energy harvester 12 in a precise manner, such that a suitable voltage output is developed by the charge pump 46 directly. Where the underlying energy harvester 12 technology employs vibration/motion techniques, a source of vibration or motion energy may be employed to drive the energy harvester 12. Likewise, where the underlying energy harvester 12 technology employs thermal energy techniques, a source of thermal energy can be employed to generate a temperature gradient, which can be converted to a suitable voltage potential. Similarly, where the underlying energy harvester 12 technology employs RF radiation techniques, a source of RF energy having a predetermined frequency and power level may be used to generate an electromagnetic beam to drive an input element of the energy harvester 12, such as for example, a coil or antenna. These and other techniques are described in more detail below.

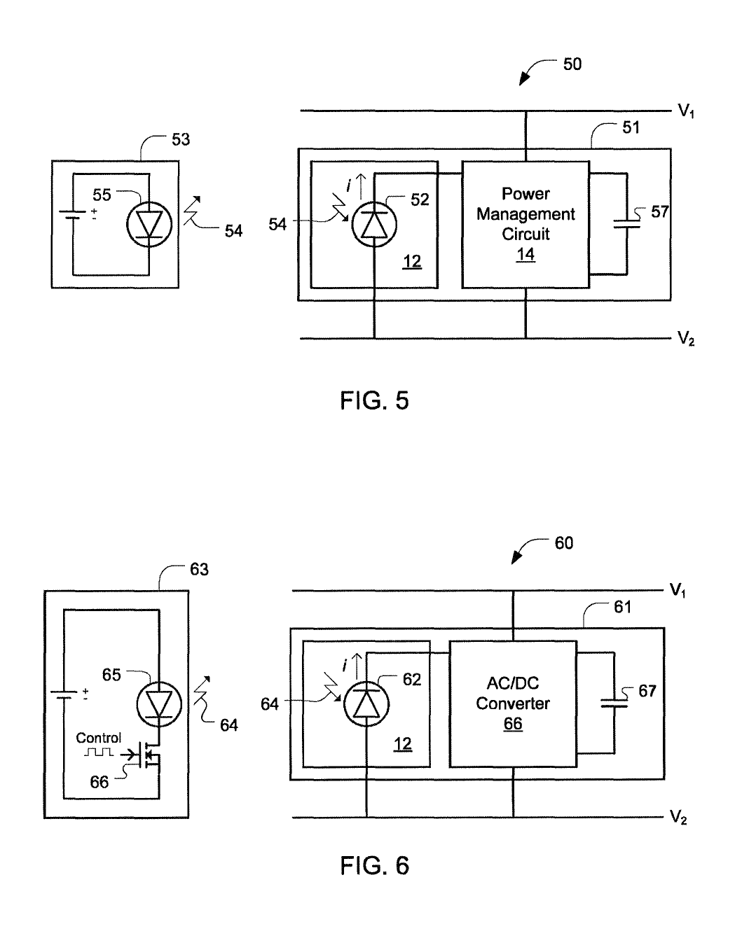

FIG. 5 illustrates one aspect of a system 50 that employs an energy harvesting technique based on optical radiation. A light source 53 located remotely from the wireless energy source 51 includes a light emitting element 55 configured to emit light 54 at a predetermined wavelength and power level. The radiated light 54 is detected by an optical energy conversion element such as a photodiode 52, similar to the photodiode 42 of FIG. 4, of the energy harvester 12. In the referenced aspect, the photodiode 52 is reverse biased and a current i (or voltage depending on the mode of operation) proportional to the amount of the light 54 that strikes the photodiode 52 is converted to a voltage potential (V1-V2) by the power management circuit 14 and is stored in a capacitor 57.

The light emitting element 55 may be a light emitting diode (LED), laser diode, laser, or any source of radiant energy capable of generating light 54 at a wavelength (or frequency) and power level suitable for generating a suitable current i through the photodiode 52. In various aspects, the light emitting element 55 may be designed and implemented to generate light 54 of a wavelength in the visible and/or invisible spectrum including the light 54 of a wavelength ranging from ultraviolet to infrared wavelengths. In one aspect, the light source 53 may be configured to radiate light of a single monochromatic wavelength. It will be appreciated by those skilled in the art that the light source 53 may comprise one or more of the light emitting element 55 that, when energized by an electrical power source, may be configured to radiate electromagnetic energy in the visible spectrum as well as the invisible spectrum. In such aspects, the light source 53 may be configured to radiate light composed of a mix of a multiple monochromatic wavelengths.

The visible spectrum, sometimes referred to as the optical spectrum or luminous spectrum, is that portion of the electromagnetic spectrum that is visible to (e.g., can be detected by) the human eye and may be referred to as visible light or simply light. A typical human eye will respond to wavelengths in air from about 380 nm to about 750 nm. The visible spectrum is continuous and without clear boundaries between one color and the next. The following ranges may be used as an approximation of color wavelength;

Violet: about 380 nm to about 450 nm;
Blue: about 450 nm to about 495 nm;
Green: about 495 nm to about 570 nm;
Yellow: about 570 nm to about 590 nm;
Orange: about 590 nm to about 620 nm; and
Red: about 620 nm to about 750 nm.

The invisible spectrum (e.g., non-luminous spectrum) is that portion of the electromagnetic spectrum lies below and above the visible spectrum (e.g., below about 380 nm and above about 750 nm). The invisible spectrum is not detectable by the human eye. Wavelengths greater than about 750 nm are longer than the red visible spectrum and they become invisible infrared, microwave, and radio electromagnetic radiation. Wavelengths less than about 380 nm are shorter than the violet spectrum and they become invisible ultra-violet, x-ray, and gamma ray electromagnetic radiation.

In various other aspects, the light emitting element 54 may be a source of radiant electromagnetic energy in the form of X-rays, microwaves, and radio waves. In such aspects, the energy harvester 12 may be designed and implemented to be compatible with the particular type of radiated electromagnetic energy emitted by the source 53.

FIG. 6 illustrates one aspect of a system 60 that employs an energy harvesting technique based on modulated optical radiation. A light source 63 located remotely from a wireless energy source 61 includes a light emitting element 65, similar to the light emitting element 55 of FIG. 5, that emits light 64 at a predetermined wavelength and power level. The light 64 is modulated by a switch 66 and is radiated at the frequency of the control signal. The modulated light 64 is detected by an optical energy conversion element such as a photodiode 62, which is similar to the photodiode 52 of FIG. 5. An alternating current (AC) current i (or voltage depending on the mode of operation) proportional to the amount of the light 64 that strikes the photodiode 62 is provided to an AC/DC converter 66, where it converted to a voltage potential (V1-V2) and is stored in a capacitor 67. The frequency of the AC current i is substantially equal to the frequency of the control signal.

In one aspect, information may be communicated from the system 60 by modulating the photodiode 62 using the light 64 modulated by the switch 66 and radiated at the frequency of the control signal. For example, when the system 60 is used as a component of an ingestible identifier, such as an IEM or a pharma-informatics enabled pharmaceutical composition, for example, information may be communicated from the system 60 by modulating the photodiode 62 with the light 64, which is radiated at the frequency of the control signal to the photodiode 62. In another aspect, a switch similar to the switch 66 may be placed in series with the photodiode 62 to modulate the photodiode with a control signal in order to communicate information from the system 60.

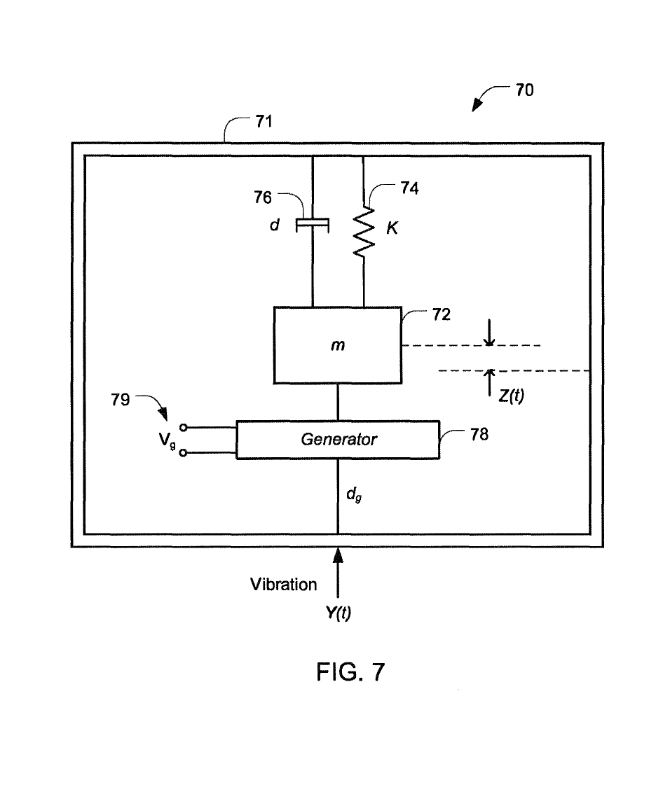

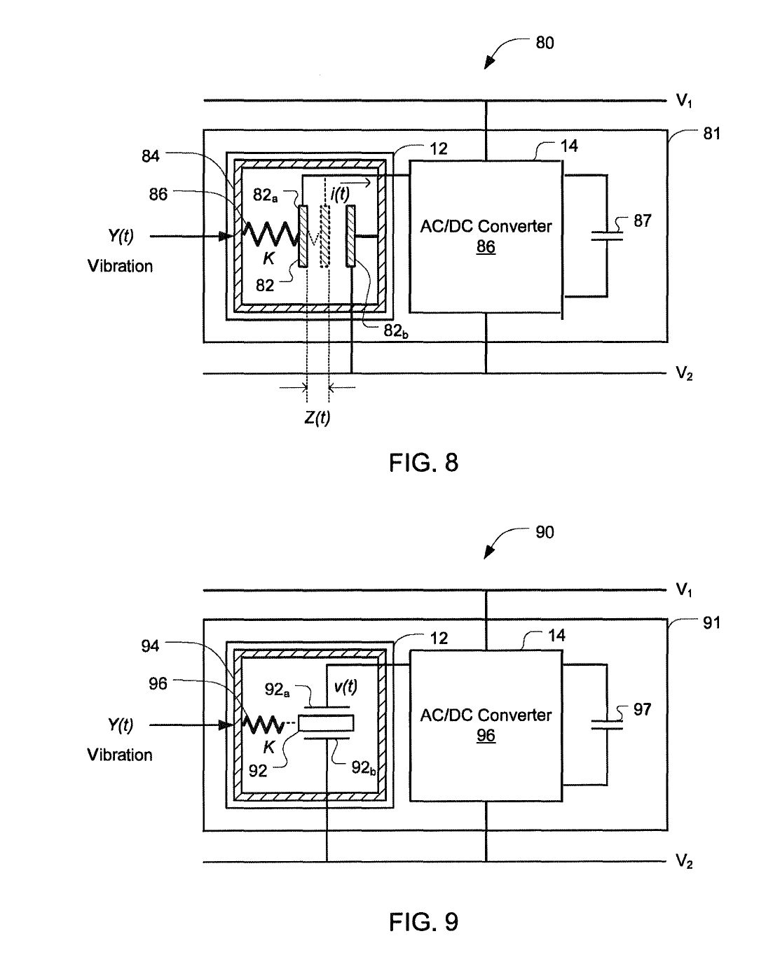

FIG. 7 is a schematic diagram of a vibration/motion system 70 that may be employed in vibration energy harvester described herein in connection with FIGS. 8-11. The vibration/motion system 70 is a model useful for understanding the general concept of converting vibration or motion energy into electrical energy. Known transducer mechanisms for converting vibration/motion energy into electrical energy are electrostatic, piezoelectric, or electromagnetic. In electrostatic transducers, a polarized capacitor produces an AC voltage when the distance or overlap of two electrodes of a polarized capacitor changes due to the movement or vibration of one movable electrode relative to the other. In piezoelectric transducers, a voltage is generated when the vibrations or movement cause the deformation of a piezoelectric capacitor. Finally, in electromagnetic transducers, an AC voltage is developed across a coil (or an AC current is induced through the coil) when a movable magnetic mass is moved relative to the coil causing a change in magnetic flux.

Referring still to FIG. 7, the vibration/motion system 70 comprises a transducer inserted in an inertial frame 71. One portion of the transducer is fixed to the frame 71 and the other portion if free to move with the vibration/motion input. The frame 71 is coupled to the source of vibration or motion and the relative motion of the portions of the transducer moves in accordance with the laws of inertia. The system 70 depicted in FIG. 7 is made resonant by attaching a moveable mass 72 to a spring 74. In other aspects, a non-resonant system may be employed where no spring is used. An energy harvester based on the vibration/motion system 70 can be treated as a velocity damped mass spring system where Z(t) represents the motion of the mass 72, d is a damper 76 coefficient due to air resistance, friction, and the like, K is the spring 74 constant of the suspension, m is the moving mass 72, and Z(t) is the amplitude of the movement of the frame 71 in the Z direction. In addition, there may be damping due to the transfer of mechanical energy to electrical energy V_{g} to a load 79 by a generator 78. It will be appreciated that electrical power may be maximized by equalizing the generator 78 and parasitic damping.

Electrostatic and piezoelectric vibration/motion based energy harvesters may be fabricated using micromachining processes such as a MEMS process. Electromagnetic energy harvesting devices may be fabricated using a combination of micromachining and mechanical tooling techniques when using large inductors (coils) with sufficient windings for efficient electromagnetic conversion, which may not necessarily be compatible with monolithic or planar microfabrication processes. Alternatively, small value inductors can be fabricated on integrated circuits using the same processes that are used to make transistors. Integrated inductors may be laid out in spiral coil patterns with aluminum interconnections. The small dimensions of integrated inductors, however, limit the value of the inductance that can be achieved in integrated coils. Another option is to use a “gyrator,” which uses capacitors and active components to create electrical behavior similar to that of an inductor.

FIG. 8 illustrates one aspect of a system 80 comprising a wireless energy source 81 that comprises the energy harvester 12 comprising an electrostatic energy conversion element to convert vibration/motion energy into electrical energy as described in connection with FIG. 7. In the aspect referenced in FIG. 8, the electrostatic energy conversion element of the energy harvester 12 converts vibration/motion energy into electrical energy using electrostatic energy conversion techniques. The energy harvester 12 transducer comprises an inertial frame 84 which contains a polarized capacitor 82 comprising a first electrode 82ₐ and a second electrode 82_{b}. The first capacitor electrode 82ₐ is connected to a movable element 86 (shown schematically as a spring with a spring constant K), which is free to move in response to a vibration/motion input Y(t). The motion of the first capacitor electrode 82a is represented by Z(t). The second electrode 82_{b} is fixed to the frame 84 and does not move relative thereto. The polarized capacitor 82 produces an AC current i(t) when the distance between the first and second electrodes 82ₐ, 82_{b} changes in response to the movement Z(t) or vibration of the first capacitor electrode 82ₐ.

An AC/DC converter 86 of the power management circuit 14 converts the AC capacitor current i(t) into a voltage potential suitable to operate the circuits of the identifier systems 16, 22, 32 of respective FIGS. 1-3. The AC/DC converter comprises a rectifier circuit to rectify the AC input into a DC output. A DC-level shifter and voltage regulator circuit also may be included in the AC/DC converter 86 to provide a suitable voltage potential (V1-V2) for the identifier systems 16, 22, 32. Although the AC/DC converter 86 may employ diodes in the rectifier portion, higher efficiency can be achieved by substituting transistor switches for the diodes because transistors have a lower voltage drop and thus are conducive to a more efficient rectification. A capacitor 87 smoothes the output voltage and acts as an energy storage device.

FIG. 9 illustrates one aspect of a system 90 comprising a wireless energy source 91 that comprises the energy harvester 12 comprising a piezoelectric energy conversion element to convert vibration/motion energy into electrical energy as described in connection with FIG. 7. In the aspect referenced in FIG. 9, the piezoelectric energy conversion element of the energy harvester 12 transducer mechanism converts vibration/motion energy into electrical energy using piezoelectric energy conversion techniques. The energy harvester 12 transducer comprises an inertial frame 94 which contains a piezoelectric capacitor 92 comprising a first electrode 92ₐ and a second electrode 92_{b}. The piezoelectric transducer 92 produces an AC voltage v(t) when the piezoelectric capacitor 92 deforms in response to the vibration/motion input Y(t). The power management circuit 14 comprises an AC/DC converter 96, similar to the AC/DC converter 86 of FIG. 8, to convert the AC voltage v(t) at its input into a voltage potential at its output that is suitable to operate the circuits of the identifier systems 16, 22, 32 of respective FIGS. 1-3. A capacitor 97 smoothes the output voltage and acts as an energy storage device.

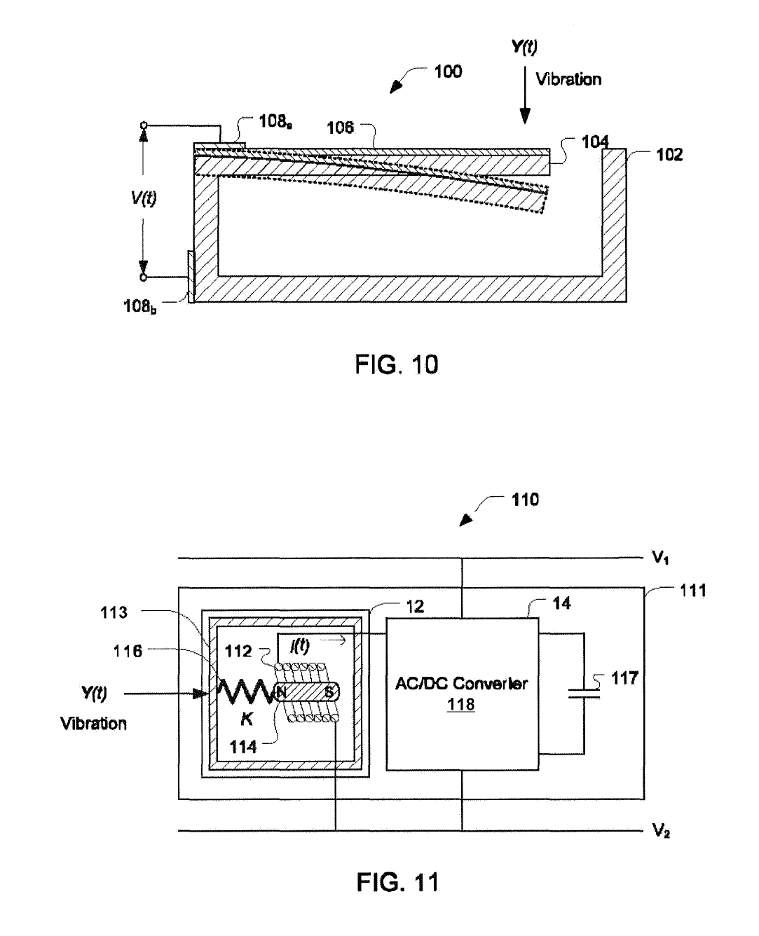

FIG. 10 is a schematic diagram of a piezoelectric type capacitor 100 element of a wireless energy source that is configured to operate on the vibration/motion energy harvesting principle described in FIG. 7. The piezoelectric capacitor 100 comprises a body 102, which acts as the inertial frame, and a cantilever 104 having one end fixed to the body 102 and a second end that is free to move in response to a vibration/motion input Y(t). The cantilever 104 may be designed and implemented to have a predetermined spring constant. The cantilever 104 comprises a thin layer of piezoelectric material 106 formed on a surface thereof. As the cantilever 104 moves in response to the vibration/motion input Y(t) an AC voltage V(t) develops across the electrodes 108ₐ and 108_{b}. The AC voltage can be converted to a suitable DC voltage potential by an AC/DC converter similar to the AC/DC converters 86, 96 of respective FIGS. 8 and 9.

FIG. 11 illustrates one aspect of a system 110 comprising a wireless energy source 111 that comprises the energy harvester 12 comprising an electromagnetic energy conversion element to convert vibration/motion energy into electrical energy as described in connection with FIG. 7. In the aspect referenced in FIG. 11, the electromagnetic energy conversion element of the energy harvester 12 transducer mechanism converts vibration/motion energy into electrical energy using electromagnetic energy conversion techniques. The energy harvester 12 transducer comprises an inertial frame 113 which contains a fixed coil 112 (e.g., inductor) and a movable magnetic mass 114 (e.g., magnet). The magnetic mass 114 has a first end fixed to a spring element 116 and a free second end. An AC current i(t) (or voltage depending on the particular implementation) is generated by the coil 112 when the movable magnetic mass 114 moves relative to the fixed coil 112 and causes a change in magnetic flux. In other aspects, an AC voltage v(t) develops across the coil 112 when the movable magnetic mass 114 moves relative to the coil 112 and causes a change in magnetic flux. It will be appreciated that in other aspects the magnetic mass 114 may be fixed and the coil 112 may be movable.

An AC/DC converter 118, similar to the AC/DC converter 86, 96 of respective FIGS. 8 and 9, converts the AC current i(t) or voltage v(t) at its input into a voltage potential at its output that is suitable to operate the circuits of the identifier systems 16, 22, 32 of respective FIGS. 1-3. A capacitor 117 smoothes the output voltage and acts as an energy storage device.

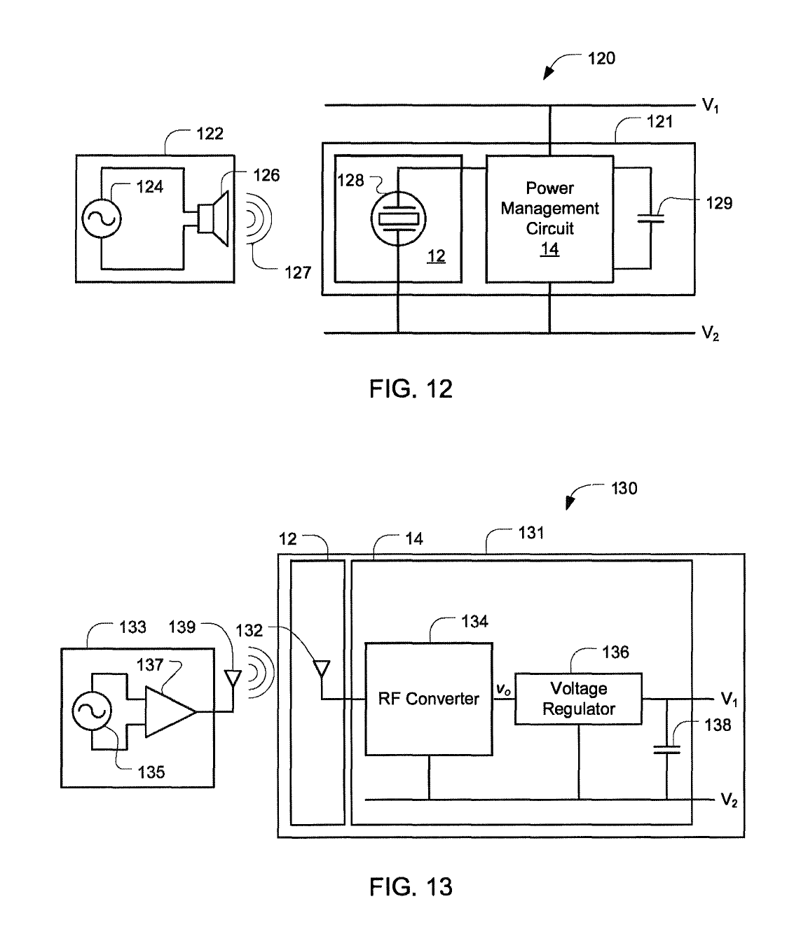

FIG. 12 illustrates one aspect of a system 120 comprising a wireless energy source 121 that comprises the energy harvester 12 comprising an acoustic energy conversion element. In the aspect referenced in FIG. 12, the acoustic energy conversion element of the energy harvester 12 transducer mechanism converts acoustic energy to electrical energy. A piezoelectric transducer 128 is configured to detect acoustic waves 127 generated by an acoustic source 122. The acoustic source 122 comprises an oscillator 124 and a speaker 126. The oscillator 124 drives the speaker 126 at a predetermined frequency. The frequency may be in the audible frequency band or in the ultrasonic energy band depending on the design and implementation of the system 120. The piezoelectric transducer 128 detects the acoustic waves 127 generated by the acoustic source 122. A voltage develops across the piezoelectric transducer 128 proportional to the acoustic pressure incident upon the piezoelectric transducer 128. The voltage is converted by the power management circuit 14 to a voltage potential suitable to operate the circuits of the identifier systems 16, 22, 32 of respective FIGS. 1-3. As described in connection with FIGS. 8, 9, and 11, the power management circuit 14 may be an AC/DC converter. A capacitor 129 smoothes the output voltage and acts as an energy storage device.

FIG. 13 illustrates one aspect of a system 130 comprising a wireless energy source 131 comprising the energy harvester 12 comprising a RF energy conversion element. In the aspect referenced in FIG. 13, the RF energy conversion element of the energy harvester 12 converts RF energy into electrical energy. The energy harvester 12 comprises an antenna 132 to receive RF energy. The power management circuit 14 comprises an RF converter 134 coupled to the input antenna 132. The RF converter 134 converts RF radiation received by the input antenna 132 to a voltage vₒ. The voltage vₒ is provided to a voltage regulator 136 to regulate the output voltage potential (V1-V2). A capacitor 138 is coupled to the output of the voltage regulator 136. The capacitor 138 smoothes the output voltage and acts as an energy storage device.

An RF source 133 is configured to generate an RF waveform. An oscillator 135 can be used to generate the frequency of the RF waveform. The output of the oscillator 135 is coupled to an amplifier 137, which determines the power level of the RF waveform. The output of the amplifier 137 is coupled to an output antenna 139, which generates an electromagnetic beam to drive the input antenna 132 of the energy harvester 12. In one aspect, the input antenna 132 may be an integrated circuit antenna.

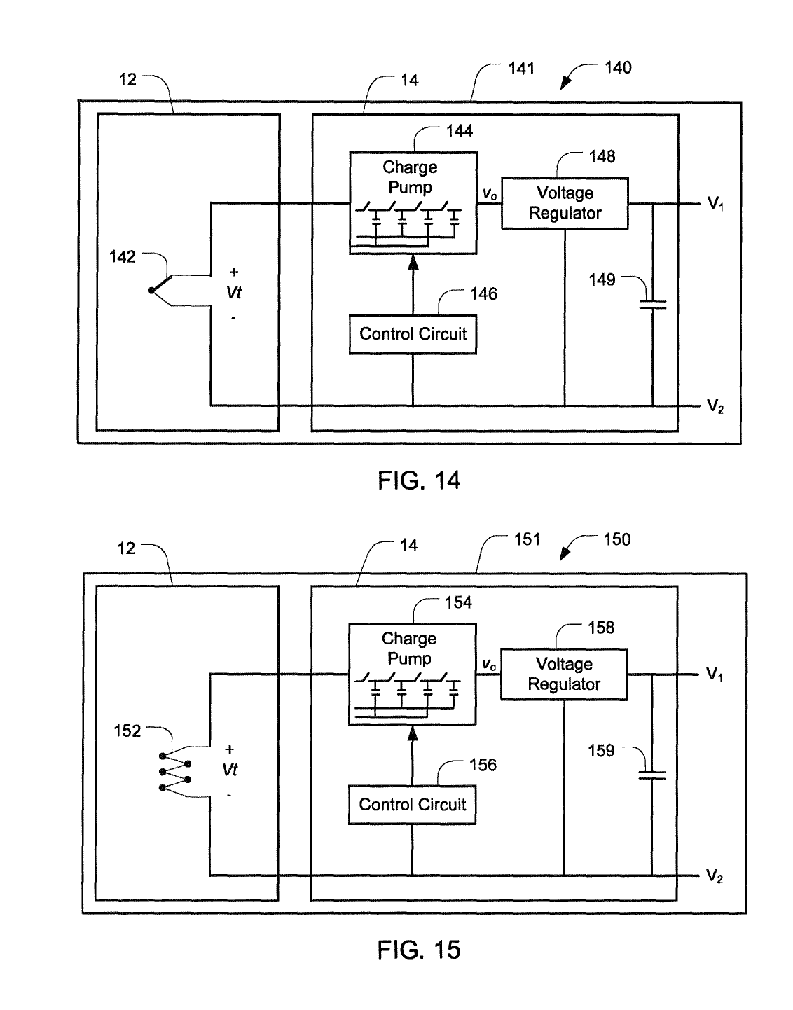

FIG. 14 illustrates one aspect of a system 140 comprising a wireless energy source 141 comprising the energy harvester 12 comprising a thermoelectric energy conversion element. In one aspect, thermoelectric energy harvesting may be based on the Seebeck effect. In other aspects, thermoelectric energy harvesting may be based on the Peltier effect. In the aspect referenced in FIG. 14, the thermoelectric energy conversion element of the energy harvester 12 converts thermal energy into electrical energy. The energy harvester 12 comprises a thermocouple 142—a junction between two different metals that produces a voltage related to a temperature difference. The thermocouple 142 can be used for converting heat energy into electric energy. Any junction of dissimilar metals may produce an electric potential related to temperature. Thermocouples are junctions of specific alloys which have a predictable and repeatable relationship between temperature and voltage. Different alloys may be used for different temperature ranges. Where the measurement point is far from the measuring wireless energy harvester 12, an intermediate connection can be made by extension wires.

The power management circuit 14 comprises a charge pump 144, similar to the charge pump 46 of FIG. 4. The charge pump 144 boosts the voltage vₜ produced by the junction of the thermocouple 142 and produces an output voltage vₒ. The charge pump 144 may have any suitable number of stages to boost the input voltage to a suitable level. A control circuit 146 controls the operation of the switching device(s) that controls the connection of voltages to the capacitors of the charge pump 144 to generate the output voltage vₒ. The output voltage vₒ is provided to a voltage regulator 148 to regulate the output voltage V1 to a voltage that is suitable to operate the circuits of the identifier systems 16, 22, 32 of FIGS. 1-3. A capacitor 149 smoothes the output voltage and acts as an energy storage device. Any suitable thermal source (e.g., hot or cold) can be used to drive the system 140.

FIG. 15 illustrates one aspect of a system 150 comprising a wireless energy source 151 comprising the energy harvester 12 comprising a thermoelectric energy conversion element similar to the element discussed in connection with FIG. 14. In the aspect referenced in FIG. 15, the thermoelectric energy conversion element of the energy harvester 12 converts thermal energy into electrical energy. The energy harvester 12 comprises a thermopile 152—an electronic device that converts thermal energy into electrical energy. The thermopile 152 comprises multiple thermocouples connected in series. In other aspects, the thermocouples may be connected in parallel. The thermopile 152 generates an output voltage vₜ that is proportional to a local temperature difference or temperature gradient.

The power management circuit 14 comprises a charge pump 154, similar to the charge pump 144 of FIG. 14. The charge pump 154 boosts the voltage vₜ produced by the thermopile 152 and produces an output voltage vₒ. A control circuit 156 controls the operation of the switching device(s) that controls the connection of voltages to the capacitors of the charge pump 154 to generate the output voltage vₒ. The output voltage vₒ is provided to a voltage regulator 158 to regulate the output voltage V1 to a voltage that is suitable to operate the circuits of the identifier systems 16, 22, 32 of FIGS. 1-3. A capacitor 159 smoothes the output voltage and acts as an energy storage device. Any suitable thermal source (e.g., hot or cold) can be used to drive the system 150.

Having described various aspects systems comprising wireless energy sources based on optical, vibration/motion, acoustic, RF, and thermal energy conversion principles, the disclosure now turns to one example application of the system 20 described in connection with FIG. 2. Briefly, the system 20 of FIG. 2 comprises the wireless energy source 21 and the identifier system 22 for indicating the occurrence of an event. The system 20 comprises a hybrid energy source comprising the wireless energy source 21 and a partial power source in the identifier system 22 that can be activated when the first and second conductive materials 26, 28 provide a voltage potential difference when in contact with a conducting fluid, which may comprise a conductive liquid, gas, mist, or any combinations thereof, to indicate an event. In the aspect referenced in FIG. 2, the event may be marked by activating the wireless energy source 21 or by contact between the conducting fluid and the system 20, more particularly, contact between the identifier system 22 and the conducting fluid.

In one aspect, the system 20 may be used with a pharmaceutical product and the event that is indicated is when the product is taken or ingested. The term “ingested” or “ingest” or “ingesting” is understood to mean any introduction of the system 20 internal to the body. For example, ingesting includes simply placing the system 20 in the mouth all the way to the descending colon. Thus, the term ingesting refers to any instant in time when the system is introduced to an environment that contains a conducting fluid. Another example would be a situation when a non-conducting fluid is mixed with a conducting fluid. In such a situation the system 20 would be present in the non-conduction fluid and when the two fluids are mixed, the system 20 comes into contact with the conducting fluid and the system is activated. Yet another example would be the situation when the presence of certain conducting fluids needed to be detected. In such instances, the presence of the system 20, which would be activated within the conducting fluid could be detected and, hence, the presence of the respective fluid would be detected.

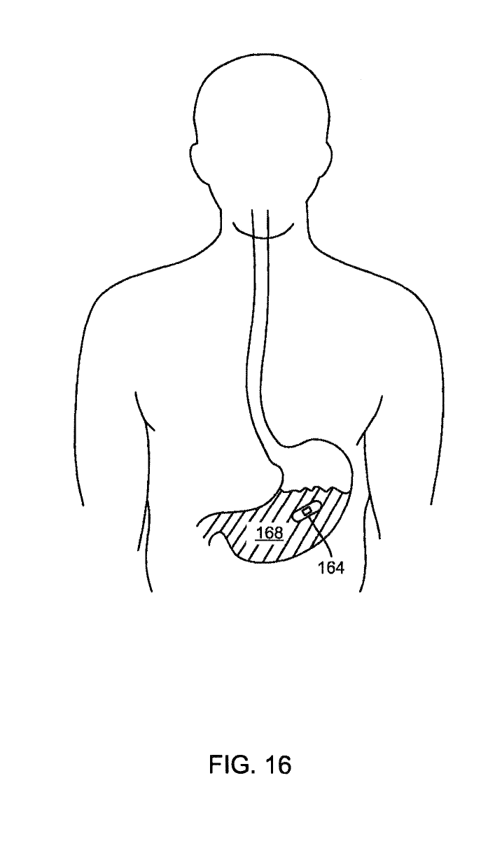

Referring now to FIGS. 2 and 16, the system 20 is used with a product 164 that is ingested by a living organism. When the product 164 that includes the system 20 is taken or ingested, the system 20 comes into contact with the conducting body fluid. When the presently disclosed system 20 comes into contact with the body fluid, a voltage potential is created and the system 20 is activated. A portion of the power source is provided by the device, while another portion of the power source is provided by the conducting fluid, which is discussed in detail below.

With reference now to FIG. 16, one aspect of the ingestible product 164 that comprises a system for indicating the occurrence of an event is shown inside the body. The system comprises a wireless energy source comprising an energy harvester and a power management circuit as described above for wireless power delivery to electronic components of the system. In the referenced aspect, the product 164 is configured as an orally ingestible pharmaceutical formulation in the form of a pill or capsule. Upon ingestion, the pill moves to the stomach. Upon reaching the stomach, the product 164 is in contact with stomach fluid 168 and undergoes a chemical reaction with the various materials in the stomach fluid 168, such as hydrochloric acid and other digestive agents. The system is discussed in reference to a pharmaceutical environment. The scope of the present disclosure, however, is not limited thereby. The product 164 and system according to the present disclosure can be used in any environment where a conducting fluid is present or becomes present through mixing of two or more components that result in a conducting liquid.

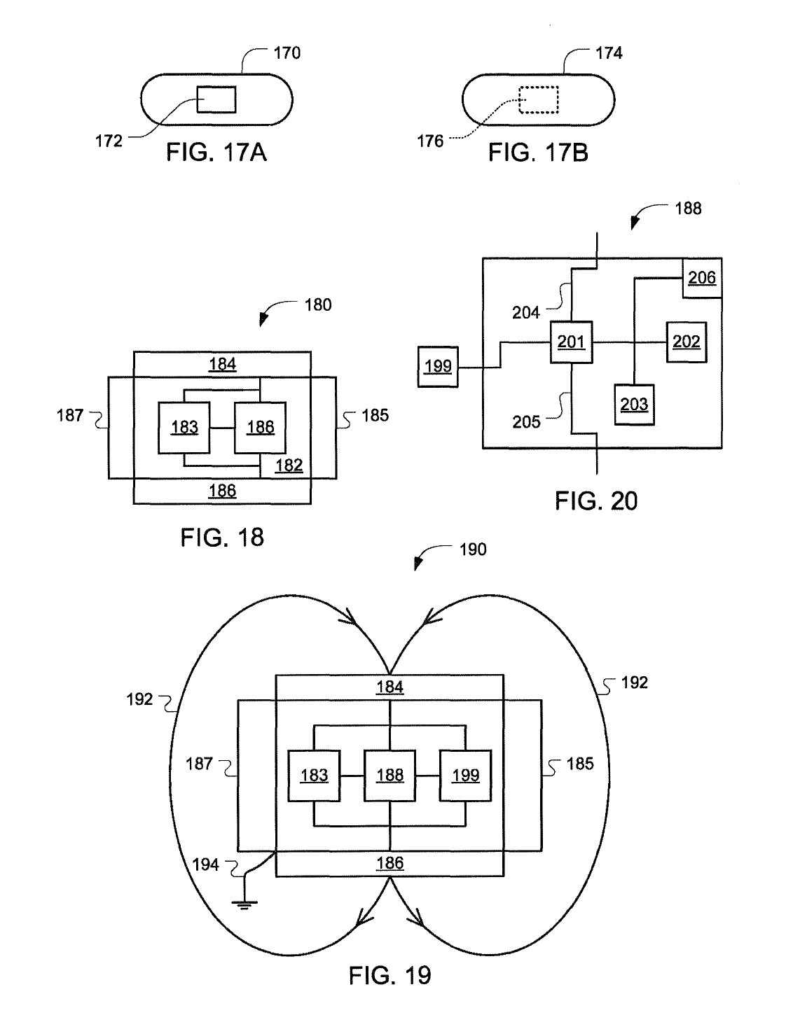

Referring now to FIG. 17A, a pharmaceutical product 170 is shown with a system 172, such as an IEM or also known as an ionic emission module. In the referenced aspect, the system 172 is similar to the system 20 of FIG. 2. In other aspects, the systems 10 and 30 of respective FIGS. 1 and 3 may be substituted for the system 20 of FIG. 2. Any of these systems 10, 20, 30 may comprise one or more than one of the wireless energy sources 51, 61, 81, 91, 111, 121, 131, 141, 151 of respective FIGS. 4-6, 8-9, and 11-15 described herein for activating the system 172 in wireless mode. For conciseness and clarity, however, only the system 20 of FIG. 2 in combination with the pharmaceutical product will be described with particularity. The scope of the present disclosure is not limited by the shape or type of the product 170. For example, it will be clear to one skilled in the art that the product 170 can be a capsule, a time-release oral dosage, a tablet, a gel cap, a sub-lingual tablet, or any oral dosage product that can be combined with the system 172. In the referenced aspect, the product 170 has the system 172 secured to the exterior using known methods of securing micro-devices to the exterior of pharmaceutical products. Example of methods for securing the micro-device to the product is disclosed in U.S. Provisional Patent Application No. 61/142,849 filed on Jan. 6, 2009 and entitled “HIGH-THROUGHPUT PRODUCTION OF INGESTIBLE EVENT MARKERS” as well as U.S. Provisional Patent Application Ser. No. 61/177,611 filed on May 12, 2009 and entitled “INGESTIBLE EVENT MARKERS COMPRISING AN IDENTIFIER AND AN INGESTIBLE COMPONENT,” where the disclosure of each is incorporated herein by reference in its entirety. Once ingested, the system 172 comes into contact with body liquids and the system 172 is activated. In galvanic mode, the system 172 uses the voltage potential difference to power up and thereafter modulates conductance to create a unique and identifiable current signature. Upon activation, the system 172 controls the conductance and, hence, current flow to produce the current signature.

The system 172 comprises a wireless energy source comprising any one of the wireless energy harvesters and power management circuits according to any one of the various aspects described herein. Thus, the system 172 may be energized by the wireless energy source without activating the system 172 with a conductive fluid.

In one aspect, the activation of the system 172 may be delayed for various reasons. In order to delay the activation of the system 172, the system 172 may be coated with a shielding material or protective layer. The layer is dissolved over a period of time, thereby allowing the system 172 to be activated when the product 170 has reached a target location.

Referring now to FIG. 17B, a pharmaceutical product 174, similar to the product 170 of FIG. 17A, is shown with a system 176, such as an IEM or an identifiable emission module. The system 176 of FIG. 17B is similar to the system 20 of FIG. 2. In other aspects, the systems 10 and 30 of respective FIGS. 1 and 3 may be substituted for the system 20 of FIG. 2. Any of these systems 10, 20, 30 may comprise a wireless energy source described herein. The scope of the present disclosure is not limited by the environment to which the system 176 is introduced. For example, the system 176 can be enclosed in a capsule that is taken in addition to/independently from the pharmaceutical product. The capsule may be simply a carrier for the system 176 and may not contain any product. Furthermore, the scope of the present disclosure is not limited by the shape or type of product 174. For example, it will be clear to one skilled in the art that the product 174 can be a capsule, a time-release oral dosage, a tablet, a gel capsule, a sub-lingual tablet, or any oral dosage product. In the referenced aspect, the product 174 has the system 176 positioned inside or secured to the interior of the product 174. In one aspect, the system 176 is secured to the interior wall of the product 176. When the system 176 is positioned inside a gel capsule, then the content of the gel capsule is a non-conducting gel-liquid. On the other hand, if the content of the gel capsule is a conducting gel-liquid, in an alternative aspect, the system 176 is coated with a protective cover to prevent unwanted activation by the gel capsule content. If the content of the capsule is a dry powder or microspheres, then the system 176 is positioned or placed within the capsule. If the product 174 is a tablet or hard pill, the system 176 is held in place inside the tablet. Once ingested, the product 174 containing the system 176 is dissolved. The system 176 comes into contact with body liquids and the system 176 is activated. Depending on the product 174, the system 176 may be positioned in either a near-central or near-perimeter position depending on the desired activation delay between the time of initial ingestion and activation of the system 176. For example, a central position for the system 176 means that it will take longer for the system 176 to be in contact with the conducting liquid and, hence, it will take longer for the system 176 to be activated. Therefore, it will take longer for the occurrence of the event to be detected.

The system 176 comprises a wireless energy source (e.g., 51, 61, 81, 91, 111, 121, 131, 141, 151 of respective FIGS. 4-6, 8-9, and 11-15) comprising any one of the wireless energy harvesters and power management circuits according to any one of the various aspects described herein. Thus, the system 176 may be energized by the wireless energy source without activating the system 176 with a conductive fluid. For energy harvesting purposes, the capsule, time-release oral dosage, tablet, hard pill, gel capsule, sub-lingual tablet, or any oral dosage product, non-conducting gel-liquid, protective cover coating, dry powder or microspheres should be selected such that they are compatible with the energy harvesting mechanism being employed. In particular, with respect to the product 174, when the system 176 is an optical system similar to the systems 41, 50, and 60 of respective FIGS. 4-6, an optically transparent aperture may be provided in the product 174 in order for the system 176 to operate properly. It will be appreciated that the optically transparent aperture may not be required if the product 174 is coated with an optically transparent gel, or other coating.

Referring now to FIG. 18, in one aspect, the systems 172 and 176 of FIGS. 17A and 17B, respectively, are shown in more detail as system 180. The system 180 can be used in association with any pharmaceutical product, as mentioned above, to determine when a patient takes the pharmaceutical product. As indicated above, the scope of the present disclosure is not limited by the environment and the product that is used with the system 180. For example, the system may be activated either in wireless mode by the wireless energy source, in galvanic mode by placing the system 180 within a capsule and the placing the capsule within the conducting fluid, or a combination thereof. The capsule would then dissolve over a period of time and release the system 180 into the conducting fluid. Thus, in one aspect, the capsule would contain the system 180 and no product. Such a capsule may then be used in any environment where a conducting fluid is present and with any product. For example, the capsule may be dropped into a container filled with jet fuel, salt water, tomato sauce, motor oil, or any similar product. Additionally, the capsule containing the system 180 may be ingested at the same time that any pharmaceutical product is ingested in order to record the occurrence of the event, such as when the product was taken.

As discussed above with reference to FIGS. 17A, 17B, the system 180 comprises a wireless energy source comprising any of the wireless energy harvesters and power management circuits described herein. Accordingly, the system 180 may be energized in wireless mode by the wireless energy source without activating the system 180 in galvanic mode by exposing the system to a conductive fluid. Alternatively, the system 180 may be energized in galvanic mode only by exposing the system 180 to a conductive fluid or may be energized in both wireless and galvanic modes. In other aspects, the system 180 may be activated in combination in the wireless mode and galvanic mode. When the system 180 is activated in wireless mode, the system 180 is operative to communicate information associated with the system 180. The information may be used for diagnosing, verifying the operation of, detecting the presence of, and testing the functionality of the system 180. In other aspects, the system is operative to communicate a unique signature associated with the system 180.

In the specific example of the system 180 combined with the pharmaceutical product, as the product or pill is ingested, the system 180 is activated in galvanic mode. The system 180 controls conductance to produce a unique current signature that is detected, thereby signifying that the pharmaceutical product has been taken. When activated in wireless mode, the system controls modulation of capacitive plates to produce a unique voltage signature associated with the system 180 that is detected.

In one aspect, the system 180 includes a framework 182. The framework 182 is a chassis for the system 180 and multiple components are attached to, deposited upon, or secured to the framework 182. In this aspect of the system 180, a digestible material 184 is physically associated with the framework 182. The material 184 may be chemically deposited on, evaporated onto, secured to, or built-up on the framework all of which may be referred to herein as “deposit” with respect to the framework 182. The material 184 is deposited on one side of the framework 182. The materials of interest that can be used as material 184 include, but are not limited to: Cu or CuI. The material 184 is deposited by physical vapor deposition, electrodeposition, or plasma deposition, among other protocols. The material 184 may be from about 0.05 to about 500 μm thick, such as from about 5 to about 100 μm thick. The shape is controlled by shadow mask deposition, or photolithography and etching. Additionally, even though only one region is shown for depositing the material, each system 180 may contain two or more electrically unique regions where the material 184 may be deposited, as desired.

At a different side, which is the opposite side as shown in FIG. 18, another digestible material 186 is deposited, such that materials 184 and 186 are dissimilar. Although not shown, the different side selected may be the side next to the side selected for the material 184. The scope of the present disclosure is not limited by the side selected and the term “different side” can mean any of the multiple sides that are different from the first selected side. Furthermore, although the shape of the system is shown as a square, the shape may be any geometrically suitable shape. The materials 184 and 186 are selected such that they produce a voltage potential difference when the system 180 is in contact with conducting liquid, such as body fluids. The materials of interest for material 186 include, but are not limited to: Mg, Zn, or other electronegative metals. As indicated above with respect to the material 184, the material 186 may be chemically deposited on, evaporated onto, secured to, or built-up on the framework. Also, an adhesion layer may be necessary to help the material 186 (as well as material 184 when needed) to adhere to the framework 182. Typical adhesion layers for the material 186 are Ti, TiW, Cr or similar material. Anode material and the adhesion layer may be deposited by physical vapor deposition, electrodeposition or plasma deposition. The material 186 may be from about 0.05 to about 500 μm thick, such as from about 5 to about 100 μm thick. However, the scope of the present disclosure is not limited by the thickness of any of the materials nor by the type of process used to deposit or secure the materials to the framework 182.

According to the disclosure set forth, the materials 184 and 186 can be any pair of materials with different electrochemical potentials. Additionally, in the aspects wherein the system 180 is used in-vivo, the materials 184 and 186 may be vitamins that can be absorbed. More specifically, the materials 184 and 186 can be made of any two materials appropriate for the environment in which the system 180 will be operating. For example, when used with an ingestible product, the materials 184 and 186 are any pair of materials with different electrochemical potentials that are ingestible. An illustrative example includes the instance when the system 180 is in contact with an ionic solution, such as stomach acids. Suitable materials are not restricted to metals, and in certain aspects the paired materials are chosen from metals and non-metals, e.g., a pair made up of a metal (such as Mg) and a salt (such as CuCI or CuI). With respect to the active electrode materials, any pairing of substances—metals, salts, or intercalation compounds—with suitably different electrochemical potentials (voltage) and low interfacial resistance are suitable.

Materials and pairings of interest include, but are not limited to, those reported in TABLE 1 below. In one aspect, one or both of the metals may be doped with a non-metal, e.g., to enhance the voltage potential created between the materials as they come into contact with a conducting liquid. Non-metals that may be used as doping agents in certain aspects include, but are not limited to: sulfur, iodine, and the like. In another aspect, the materials are copper iodine (CuI) as the anode and magnesium (Mg) as the cathode. Aspects of the present disclosure use electrode materials that are not harmful to the human body.

TABLE 1

| | Anode | Cathode |
|---|---|---|
| Metals | Magnesium, Zinc | |
| | Sodium (†), Lithium (†) | |
| | Iron | |
| Salts | | Copper salts: iodide, |
| | | chloride, bromide, sulfate, |
| | | formate, (other anions possible) |
| | | Fe³⁺ salts: e.g. orthophosphate, |
| | | pyrophosphate, (other |
| | | anions possible) |
| | | Oxygen (††) on platinum, |
| | | gold or other catalytic surfaces |
| Intercalation | Graphite with Li, K, Ca, | Vanadium oxide Manganese |
| compounds | Na, Mg | oxide |

Thus, when the system 180 is in contact with the conducting fluid, a current path, an example is shown in FIG. 19, is formed through the conducting fluid between material 184 and 186. A control device 188 is secured to the framework 182 and electrically coupled to the materials 184 and 186. The control device 188 includes electronic circuitry, for example control logic that is capable of controlling and altering the conductance between the materials 184 and 186.

The voltage potential created between the materials 184 and 186 provides the power for operating the system as well as produces the current flow through the conducting fluid and the system 180. In one aspect, the system 180 operates in direct current mode. In an alternative aspect, the system 180 controls the direction of the current so that the direction of current is reversed in a cyclic manner, similar to alternating current. As the system reaches the conducting fluid or the electrolyte, where the fluid or electrolyte component is provided by a physiological fluid, e.g., stomach acid, the path for current flow between the materials 184 and 186 is completed external to the system 180; the current path through the system 180 is controlled by the control device 188. Completion of the current path allows for the current to flow and in turn a receiver, not shown, can detect the presence of the current and recognize that the system 180 has been activate and the desired event is occurring or has occurred.

In one aspect, the two materials 184 and 186 are similar in function to the two electrodes needed for a direct current power source, such as a battery. The conducting liquid acts as the electrolyte needed to complete the power source. The completed power source described is defined by the physical chemical reaction between the materials 184 and 186 of the system 180 and the surrounding fluids of the body. The completed power source may be viewed as a power source that exploits reverse electrolysis in an ionic or a conduction solution such as gastric fluid, blood, or other bodily fluids and some tissues. Additionally, the environment may be something other than a body and the liquid may be any conducting liquid. For example, the conducting fluid may be salt water or a metallic based paint.

In certain aspects, the two materials 184 and 186 are shielded from the surrounding environment by an additional layer of material. Accordingly, when the shield is dissolved and the two dissimilar materials are exposed to the target site, a voltage potential is generated.

In certain aspects, the complete power source or supply is one that is made up of active electrode materials, electrolytes, and inactive materials, such as current collectors, packaging. The active materials are any pair of materials with different electrochemical potentials. Suitable materials are not restricted to metals, and in certain aspects the paired materials are chosen from metals and non-metals, e.g., a pair made up of a metal (such as Mg) and a salt (such as CuI). With respect to the active electrode materials, any pairing of substances—metals, salts, or intercalation compounds—with suitably different electrochemical potentials (voltage) and low interfacial resistance are suitable.

A variety of different materials may be employed as the materials that form the electrodes. In certain aspects, electrode materials are chosen to provide for a voltage upon contact with the target physiological site, e.g., the stomach, sufficient to drive the system of the identifier. In certain aspects, the voltage provided by the electrode materials upon contact of the metals of the power source with the target physiological site is 0.001 V or higher, including 0.01 V or higher, such as 0.1 V or higher, e.g., 0.3 V or higher, including 0.5 volts or higher, and including 1.0 volts or higher, where in certain aspects, the voltage ranges from about 0.001 to about 10 volts, such as from about 0.01 to about 10 V.

Referring again to FIG. 18, the materials 184 and 186 provide the voltage potential to activate the control device 188. Once the control device 188 is activated or powered up, the control device 188 can alter conductance between the first and second materials 184 and 186 in a unique manner. By altering the conductance between the first and second materials 184 and 186, the control device 38 is capable of controlling the magnitude of the current through the conducting liquid that surrounds the system 180. This produces a unique current signature that can be detected and measured by a receiver (not shown), which can be positioned internal or external to the body. In addition to controlling the magnitude of the current path between the materials, non-conducting materials, membrane, or “skirt” are used to increase the “length” of the current path and, hence, act to boost the conductance path, as disclosed in the U.S. Patent Application Publication No. 2009/0082645 (Ser. No. 12/238,345) entitled “IN-BODY DEVICE WITH VIRTUAL DIPOLE SIGNAL AMPLIFICATION” published Mar. 26, 2009, the entire content of which is incorporated herein by reference. Alternatively, throughout the disclosure herein, the terms “non-conducting material,” “membrane,” and “skirt” are interchangeably with the term “current path extender” without impacting the scope or the present aspects and the claims herein. The skirt, shown in portion at 185 and 187, respectively, may be associated with, e.g., secured to, the framework 182. Various shapes and configurations for the skirt are contemplated as within the scope of the present disclosure. For example, the system 180 may be surrounded entirely or partially by the skirt and the skirt maybe positioned along a central axis of the system 180 or off-center relative to a central axis. Thus, the scope of the present disclosure as claimed herein is not limited by the shape or size of the skirt. Furthermore, in other aspects, the materials 184 and 186 may be separated by one skirt that is positioned in any defined region between the materials 184 and 186.

In addition to the above components, the system 180 also comprises a wireless energy source 183 for activating the system 180 in wireless mode. As previously discussed, the system 183 may be energized in wireless mode, galvanic mode, or a combination thereof. In the referenced aspect, the wireless energy source 183 is similar to the wireless energy source 21 and more particularly to the wireless energy source 41 of FIG. 4. In other aspects, the wireless energy source 183 may be implemented as any one of the wireless energy sources 51, 61, 81, 91, 111, 121, 131, 141, 151 of respective FIGS. 4-6, 8-9, and 11-15.

Accordingly, as previously discussed, the wireless energy source 183 comprises an energy harvester and power management circuit configured to harvest energy from the environment using optical radiation techniques as described in connection with FIG. 4. The energy harvester comprises a photodiode configured to convert incoming radiant electromagnetic energy in the form of light photons into electrical energy. The particular photodiode may be selected to optimally respond to the wavelength of the incoming light, which can range from the visible spectrum to the invisible spectrum. As used herein the term radiant electromagnetic energy refers to light in the visible or invisible spectrum ranging from the ultraviolet to the infrared frequency range. A charge pump DC-DC converter boosts the voltage level suitable to operate the control device 188 and activate the system in a wireless mode. Once activated, the control device 188 modulates the voltage on the capacitive plate elements formed by the first material 184 and the second material 186 to communicate information associated with the system 180. The modulated voltage can be detected by a capacitively coupled reader (not shown).

Referring now to FIG. 19, a system 190, which is similar to the system 180 of FIG. 18 with the addition of a sensor 199 element coupled to the control device, is shown in an activated state and in contact with conducting liquid. The system 190 is grounded through ground contact 194. The system 190 also includes the sensor module 199, which is described in greater detail in connection with FIG. 20. Ion or current paths 192 are established between the first material 184 to the second material 186 and through the conducting fluid in contact with the system 180. The voltage potential created between the first and second materials 184 and 186 is created through chemical reactions between the first and second materials 184/186 and the conducting fluid. The surface of the first material 184 is not planar, but rather an irregular surface. The irregular surface increases the surface area of the material and, hence, the area that comes in contact with the conducting fluid.

In one aspect, at the surface of the first material 184, there is chemical reaction between the material 184 and the surrounding conducting fluid such that mass is released into the conducting fluid. The term mass as used herein refers to protons and neutrons that form a substance. One example includes the instant where the material is CuCI and when in contact with the conducting fluid, CuCI becomes Cu (solid) and Cl— in solution. The flow of ions into the conduction fluid is depicted by the ion paths 192. In a similar manner, there is a chemical reaction between the second material 186 and the surrounding conducting fluid and ions are captured by the second material 186. The release of ions at the first material 184 and capture of ion by the second material 186 is collectively referred to as the ionic exchange. The rate of ionic exchange and, hence the ionic emission rate or flow, is controlled by the control device 188. The control device 188 can increase or decrease the rate of ion flow by altering the conductance, which alters the impedance, between the first and second materials 184 and 186. Through controlling the ion exchange, the system 180 can encode information in the ionic exchange process. Thus, the system 180 uses ionic emission to encode information in the ionic exchange.

The control device 188 can vary the duration of a fixed ionic exchange rate or current flow magnitude while keeping the rate or magnitude near constant, similar to when the frequency is modulated and the amplitude is constant. Also, the control device 188 can vary the level of the ionic exchange rate or the magnitude of the current flow while keeping the duration near constant. Thus, using various combinations of changes in duration and altering the rate or magnitude, the control device 188 encodes information in the current flow or the ionic exchange. For example, the control device 188 may use, but is not limited to any of the following techniques namely, Binary Phase-Shift Keying (PSK), Frequency Modulation (FM), Amplitude Modulation (AM), On-Off Keying, and PSK with On-Off Keying.

As indicated above, the various aspects disclosed herein, such as the system 180 of FIG. 18, comprise electronic components as part of the control device 188. Components that may be present include but are not limited to: logic and/or memory elements, an integrated circuit, an inductor, a resistor, and sensors for measuring various parameters. Each component may be secured to the framework and/or to another component. The components on the surface of the support may be laid out in any convenient configuration. Where two or more components are present on the surface of the solid support, interconnects may be provided.

As indicated above, the system 180 controls the conductance between the dissimilar materials and, hence, the rate of ionic exchange or the current flow. Through altering the conductance in a specific manner the system is capable of encoding information in the ionic exchange and the current signature. The ionic exchange or the current signature is used to uniquely identify the specific system. Additionally, the system 180 is capable of producing various different unique exchanges or signatures and, thus, provides additional information. For example, a second current signature based on a second conductance alteration pattern may be used to provide additional information, which information may be related to the physical environment. To further illustrate, a first current signature may be a very low current state that maintains an oscillator on the chip and a second current signature may be a current state at least a factor of ten higher than the current state associated with the first current signature.

FIG. 20 is a block diagram representation of the device 188 described in connection with FIGS. 18 and 19. The device 188 includes a control module 201, a counter or clock 202, and a memory 203. Additionally, the device 188 is shown to include a sensor module 206 as well as the sensor module 199, which was referenced in FIG. 19. The control module 201 has an input 204 electrically coupled to the first material 184 (FIGS. 18, 19) and an output 205 electrically coupled to the second material 186 (FIGS. 18, 19). The control module 201, the clock 202, the memory 203, and the sensor modules 206/199 also have power inputs (some not shown). In one aspect, the power for each of these components is supplied by the voltage potential produced by the chemical reaction between the first and second materials 184 and 186 and the conducting fluid, when the system 190 is in contact with the conducting fluid. In another aspect, the power for each of these components is supplied by the voltage potential produced by a wireless energy source. The control module 201 controls the conductance through logic that alters the overall impedance of the system 190. The control module 201 is electrically coupled to the clock 202. The clock 202 provides a clock cycle to the control module 201. Based upon the programmed characteristics of the control module 201, when a set number of clock cycles have passed, the control module 201 alters the conductance characteristics between the first and second materials 184 and 186. This cycle is repeated and thereby the control device 188 produces a unique current signature characteristic. The control module 201 is also electrically coupled to the memory 203. Both the clock 202 and the memory 203 are powered by the voltage potential created between the first and second materials 184 and 186.

Additionally, the control module 201 is electrically coupled to and in communication with the sensor modules 206 and 199. In the aspects shown, the sensor module 206 is part of the control device 188 and the sensor module 199 is a separate component. In alternative aspects, either one of the sensor modules 206 and 199 can be used without the other. The scope of the present disclosure, however, is not limited by the structural or functional location of the sensor modules 206 or 199. Additionally, any component of the system 190 may be functionally or structurally moved, combined, or repositioned without limiting the scope of the present disclosure. Thus, it is possible to have one single structure, for example a processor, which is designed to perform the functions of all of the following modules: the control module 201, the clock 202, the memory 203, and the sensor module 206 or 199. On the other hand, it is also within the scope of the present disclosure to have each of these functional components located in independent structures that are linked electrically and able to communicate.

Referring again to FIG. 20, the sensor modules 206 or 199 can include any of the following sensors: temperature, pressure, pH level, and conductivity. In one aspect, the sensor modules 206 or 199 gather information from the environment and communicate the analog information to the control module 201. The control module then converts the analog information to digital information and the digital information is encoded in the current flow or the rate of the transfer of mass that produces the ionic flow. In another aspect, the sensor modules 206 or 199 gather information from the environment and convert the analog information to digital information and then communicate the digital information to control module 201. In the aspect shown in FIG. 20, the sensor module 199 is shown as being electrically coupled to the first and second materials 184 and 186 as well as the control device 188. In another aspect, as shown in FIG. 20, the sensor module 199 is electrically coupled to the control device 188 at the connection 204. The connection 204 acts both as a source for power supply to the sensor module 199 and a communication channel between the sensor module 199 and the control device 188.

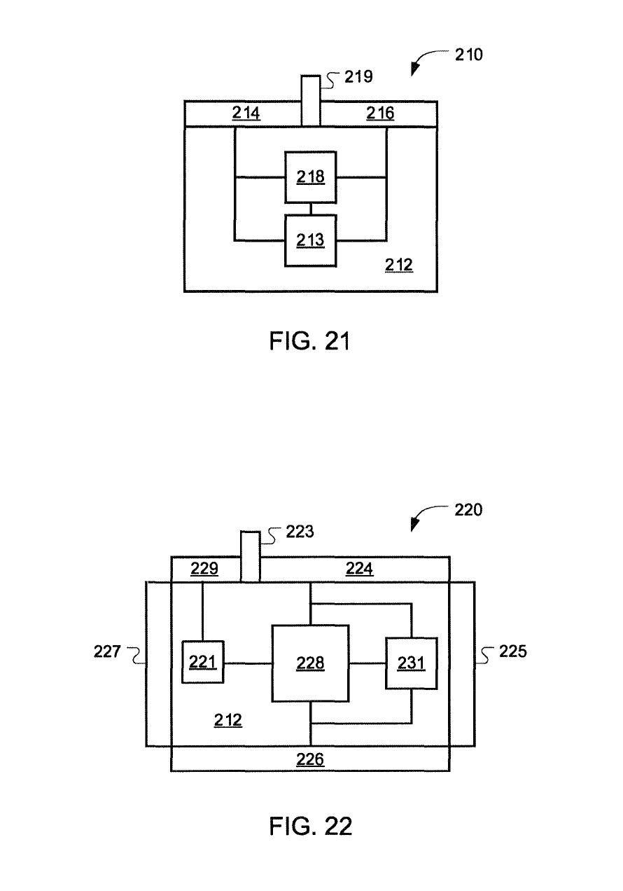

Referring now to FIG. 21, in another aspect, the systems 170 and 174 of FIGS. 17A and 17B, respectively, are shown in more detail as system 210. The system 210 includes a framework 212. The framework 212 is similar to the framework 182 of FIG. 18. In this aspect of the system 210, a digestible or dissolvable first material 214 is deposited on a portion of one side of the framework 212. At a different portion of the same side of the framework 212, another digestible second material 216 is deposited, such that the first and second materials 214 and 216 are dissimilar. More specifically, material 214 and 216 are selected such that they form a voltage potential difference when in contact with a conducting liquid, such as body fluids. Thus, when the system 210 is in contact with and/or partially in contact with the conducting liquid, then the current path 192, an example is shown in FIG. 19, is formed through the conducting liquid between the first and second material 214 and 216. A control device 218 is secured to the framework 212 and electrically coupled to the first and second materials 214 and 216. The control device 218 includes electronic circuitry that is capable of controlling part of the conductance path between the first and second materials 214 and 216. The first and second materials 214 and 216 are separated by a non-conducting skirt 219. Various examples of the skirt 219 are disclosed in U.S. Provisional Patent Application Ser. No. 61/173,511 filed on Apr. 28, 2009 and entitled “HIGHLY RELIABLE INGESTIBLE EVENT MARKERS AND METHODS OF USING SAME” and U.S. Provisional Patent Application Ser. No. 61/173,564 filed on Apr. 28, 2009 and entitled “INGESTIBLE EVENT MARKERSHAVING SIGNAL AMPLIFIERS THAT COMPRISE AN ACTIVE AGENT”; as well as U.S. Patent Application Publication No. 2009/0082645 (Ser. No. 12/238,345) published Mar. 26, 2009 and entitled “IN-BODY DEVICE WITH VIRTUAL DIPOLE SIGNAL AMPLIFICATION”; the entire disclosure of each is incorporated herein by reference.

When the control device 218 is activated or powered up, either in wireless mode or galvanic mode, the control device 218 can alter conductance between the materials 214 and 216. Thus, the control device 218 is capable of controlling the magnitude of the current through the conducting liquid that surrounds the system 210. As described with respect to the system 180 of FIG. 18, a unique current signature that is associated with the system 210 can be detected by a receiver (not shown) to mark the activation of the system 210. In order to increase the length of the current path the size of the skirt 219 is altered. The longer the current path, the easier it may be for the receiver to detect the current.

In addition to the above components, the system 210 also comprises a wireless energy source 213 for activating the system 210 in wireless mode. As previously discussed, the system 210 may be energized in wireless mode, galvanic mode, or a combination thereof. In the referenced aspect, the wireless energy source 213 is similar to the wireless energy source 21 of FIG. 2 and more particularly to the wireless energy source 41 of FIG. 4. In other aspects, the wireless energy source 213 may be implemented as any one of the wireless energy sources 51, 61, 81, 91, 111, 121, 131, 141, 151 of respective FIGS. 4-6, 8-9, and 11-15. Accordingly, as previously discussed, the wireless energy source 213 comprises an energy harvester and power management circuit configured to harvest energy from the environment using optical radiation techniques as described in connection with FIG. 4. The energy harvester comprises a photodiode configured to convert incoming radiant electromagnetic energy in the form of light photons into electrical energy. The particular photodiode may be selected to optimally respond to the wavelength of the incoming light, which can range from the visible spectrum to the invisible spectrum. As used herein the term radiant electromagnetic energy refers to light in the visible or invisible spectrum ranging from the ultraviolet to the infrared frequency range. A charge pump DC-DC converter boosts the voltage level suitable to operate the control device 218 and activate the system in a wireless mode. Once activated, the control device 218 modulates the voltage on the capacitive plate elements formed by the first material 214 and the second material 216 to communicate information associated with the system 210. The modulated voltage can be detected by a capacitively coupled reader (not shown).

Referring now to FIG. 22, a system 220, similar to the system 180 of FIG. 18, includes a pH sensor module 221 connected to a material 229, which is selected in accordance with the specific type of sensing function being performed. The pH sensor module 221 is also connected to a control device 228. The material 229 is electrically isolated from a material 224 by a non-conductive barrier 223. In one aspect, the material 229 is platinum. In operation, the pH sensor module 221 uses the voltage potential difference between the materials 224/226. The pH sensor module 221 measures the voltage potential difference between the material 224 and the material 229 and records that value for later comparison. The pH sensor module 221 also measures the voltage potential difference between the material 229 and the material 226 and records that value for later comparison. The pH sensor module 221 calculates the pH level of the surrounding environment using the voltage potential values. The pH sensor module 221 provides that information to the control device 228. The control device 228 varies the rate of the transfer of mass that produces the ionic transfer and the current flow to encode the information relevant to the pH level in the ionic transfer, which can be detected by a receiver (not shown). Thus, the system 220 can determine and provide the information related to the pH level to a source external to the environment.

As indicated above, the control device 228 can be programmed in advance to output a pre-defined current signature. In another aspect, the system can include a receiver system that can receive programming information when the system is activated. In another aspect, not shown, the clock 202 and the memory 203 of FIG. 20 can be combined into one device.

In addition to the above components, the system 220 also comprises a wireless energy source 231 for activating the system 220 in wireless mode. As previously discussed, the system 220 may be energized in wireless mode, galvanic mode, or a combination thereof. In the referenced aspect, the wireless energy source 231 is similar to the wireless energy source 21 of FIG. 2 and more particularly to the wireless energy source 41 of FIG. 4. In other aspects, the wireless energy source 231 may be implemented as any one of the wireless energy sources 51, 61, 81, 91, 111, 121, 131, 141, 151 of respective FIGS. 4-6, 8-9, and 11-15. Accordingly, as previously discussed, the wireless energy source 231 comprises an energy harvester and power management circuit configured to harvest energy from the environment using optical radiation techniques as described in connection with FIG. 4. The energy harvester comprises a photodiode configured to convert incoming radiant electromagnetic energy in the form of light photons into electrical energy. The particular photodiode may be selected to optimally respond to the wavelength of the incoming light, which can range from the visible spectrum to the invisible spectrum. As used herein the term radiant electromagnetic energy refers to light in the visible or invisible spectrum ranging from the ultraviolet to the infrared frequency range. A charge pump DC-DC converter boosts the voltage level suitable to operate the control device 228 and activate the system in a wireless mode. Once activated, the control device 228 modulates the voltage on the capacitive plate elements formed by the first material 229 and the second material 224 to communicate information associated with the system 220. The modulated voltage can be detected by a capacitively coupled reader (not shown).

In addition to the above components, the system 220 may also include one or other electronic components. Electrical components of interest include, but are not limited to: additional logic and/or memory elements, e.g., in the form of an integrated circuit; a power regulation device, e.g., battery, fuel cell or capacitor; a sensor, a stimulator; a signal transmission element, e.g., in the form of an antenna, electrode, coil; a passive element, e.g., an inductor, resistor.

FIG. 23 is a schematic diagram of a pharmaceutical product supply chain management system 230. The supply chain management system 230 is designed to manage the supply of a pharmaceutical product 237 comprising a system 239, such as an IEM or an ionic emission module comprising a wireless energy source in accordance with the various aspects of the wireless energy sources described herein. The system 239 is representative of the systems 180, 190, 188, 210, 220 of respective FIGS. 18-22. In the referenced aspect, the pharmaceutical product 237 comprises a wireless energy source similar to the wireless energy source 21 of FIG. 2 and more particularly to a wireless energy source 41 of FIG. 4. In other aspects, the wireless energy source may be implemented as any one of the wireless energy sources 51, 61, 81, 91, 111, 121, 131, 141, 151 of respective FIGS. 4-6, 8-9, and 11-15.

The supply chain management system 230 is used to probe the pharmaceutical product 237 in a wireless mode to energize the system 239 and conduct diagnostic tests, verify operation, detect presence, and determine functionality of the pharmaceutical product 237 in the supply chain. In other aspects, the system 239, when energized, is operative to communicate a unique current signature associated with the pharmaceutical product 237 to a computer system 236 to determine the validity or invalidity of the pharmaceutical product 237 based on information communicated.

In various aspects, the supply management system 230 comprises an optical energy source 232 such as a laser, for example, capable of generating an optical beam 234 to activate the wireless energy source and probe the system 239. When energized, a capacitive coupling device comprising first and second capacitive plates 238ₐ, 238_{b} detect information communicated by the system 239. The information detected by the capacitive plates 238ₐ, 238_{b} is provided to a computer system 236, which determines the validity or invalidity of the pharmaceutical product 237. In this manner, various supply chain or other pursuits may be accomplished.

The products include, for example, IV bags, syringes, IEMs, and similar devices, as disclosed and described in: PCT Patent Application Serial No. PCT/US2006/016370 published as WO/2006/116718; PCT Patent Application Serial No. PCT/US2007/082563 published as WO/2008/052136; PCT Patent Application Serial No. PCT/US2007/024225 published as WO/2008/063626; PCT Patent Application Serial No. PCT/US2007/022257 published as WO/2008/066617; PCT Patent Application Serial No. PCT/US2008/052845 published as WO/2008/095183; PCT Patent Application Serial No. PCT/US2008/053999 published as WO/2008/101107; PCT Patent Application Serial No. PCT/US2008/056296 published as WO/2008/112577; PCT Patent Application Serial No. PCT/US2008/056299 published as WO/2008/112578; PCT Patent Application Serial No. PCT/US2008/077753 published as WO 2009/042812; PCT Patent Application Serial No. PCT/US09/53721 published as WO 2012/092209; PCT Patent Application Serial No. PCT/US2007/015547 published as WO 2008/008281; and U.S. Provisional Patent Application Ser. Nos. 61/142,849; 61/142,861; 61/177,611; 61/173,564; where each of the above applications is incorporated herein by reference in its entirety. Such products typically may be designed and implemented to include conductive materials/components and wireless energy sources. Probing of the product's conductive materials/components by the capacitive plates may indicate the presence of the correct configuration of conductive components of the product. Alternatively, failure to communicatively couple when probed may indicate product nonconformance, e.g., one or more conductive materials is absent, incorrectly configured.

As illustrated, an IEM, such as the system 239 configured inside the pharmaceutical product 237 with excipient is completely packaged up and tested via the optical energy source 232 probe to ensure, for example, the IEM is still functioning and doing so in a way that is non-contacting or perhaps contacting and uses optical probing to energize the IEM and capacitive coupling to detect the information communicated by the IEM by non-contacting capacitive plates. The first probing capacitive plate 238ₐ is coupled to a first metal or material on one side of the framework of the IEM and the second probing capacitive plate 238_{b} is coupled to a second metal or material on another side of the framework of the IEM. For example, the pharmaceutical product 237 may be coated with something to keep it stable and such a coating may likely be a non-conductive material. Various ways to capacitively couple the system 237 may be accomplished, e.g., metal, metal pads. As shown in FIG. 23, the first and second capacitive plates 238ₐ, 238_{b} are capacitively coupled to corresponding first and second materials formed on the framework of the system 237.

FIG. 24 is schematic diagram of a circuit 250 that may be representative of various aspects. The first and second capacitive plates 238ₐ, 238_{b} are coupled to the input of a sensing amplifier 252. The output of the amplifier 252 is provided to the computer system 236. When the pharmaceutical product 237 is introduced between the first and second capacitive plates 238ₐ, 238_{b}, the optical energy source 232 (FIG. 23) such as a laser, for example, energizes the system 239 with the optical beam 234. The controller then modulates a voltage on the first and second materials of the system 239. A modulated voltage 254 is detected by the capacitive plates 238ₐ, 238_{b}, amplified by an amplifier 252, and provided to the computer system 236, which may conduct diagnostic tests on the system 239, verify operation of the system 239, detect the presence of the system 239 in the pharmaceutical product 237, and test the functionality of the system 239 in the supply chain. In other aspects, the computer system 236 receives a unique current signature associated with the pharmaceutical product 237. Overall, the computer system 236 determines the validity or invalidity of the pharmaceutical product 237 based on the information communicated during the probing process.

In various aspects, the capacitive coupling device may be used with any devices designed and implemented with a wireless energy source, e.g., IEM or similar devices which may be DC source devices that are modified for interoperability, e.g., a device having a rectifier in place to provide a stable voltage on the chip, the impedance of which may be modulated.

In various aspects, the capacitive plates 238ₐ, 238_{b} may be integrated or otherwise associated with various structural components and other devices, e.g., a tubular structure having capacitive plates. One or more pharmaceutical products 237 having an IEM or similar device may be introduced into, e.g., manually, via automated means, and the IEM is probed by the capacitive plates in the tube when the wireless energy source of the system 239 is energized by the probing source 232 (FIG. 23).

In one aspect, a method of testing the pharmaceutical product 237 having a first conductive region and a second conductive region is provided. The pharmaceutical product 237 is introduced into a capacitive coupling device. The wireless energy source within the system 239 of the pharmaceutical product 237 is probed by a source to energize the system 239. A first capacitive plate of the capacitive coupling device is capacitively coupled to the first conductive region of the system 239 and a second capacitive plate of the capacitive coupling device is capacitively coupled to the second conduction region of the system 239. The computer system 236 is coupled to the capacitive device. The computer system 236 comprises a data storage element to store data associated with the information stored in the system 239.

In various aspects, other devices and/or components may be associated. In one example, a programmable device may be communicatively associated with the capacitive coupling device to receive, communicate, data and/or information derived by the capacitive coupling device. To continue with the foregoing illustration, once all or a portion of the number of the pharmaceutical products 237 are “read” by the capacitive coupling device, the capacitive coupling device may communicate, e.g., wireless, wired, to the computer system 236, which may include a database and display device for further storage, display, manipulation. In this manner, an individual datum, data, large volumes of date, may be processed for various purposes. One such purpose may be, for example, to track pharmaceuticals in a supply chain application, e.g., during a manufacturing process such as a tablet pressing or other process, during a pharmacy verification process, during a pharmacy prescription process. Various processes may be complementary, incorporated. One such example is validation through reading the number. If it is valid, e.g., readable, the tablet is accepted. If not, the tablet is rejected.

In another aspect, a pharmaceutical product having an IC chip, e.g., IEM, with a skirt, such as the skirts 185, 187 of the system 180 shown in FIGS. 18 and 19, for example. In one example, the pill is coated with a non-conductive or fairly impervious coating (as shown) and the pill itself comprises a non-conductive medicine powder. A region, e.g., a cone-shaped region, for example, comprises a conductive material, e.g., small particles or grains of conductive material intermixed with other pharmaceutical material(s), excipient(s), placebo material(s), such that the region is converted into a conductive region. For example, graphite and other conductive materials may be used, e.g., one part in ten, five parts in ten, such that the region is conductive. Other materials and compositions are possible, e.g., a gel or liquid capsule having conductive particles therein. Thus, at high enough frequencies, the conductive particles may be shorted together. One skilled in the art will recognize that the conductive material(s) may include various materials and form factors, as well as combinations thereof, e.g., variously sized particles, wires, metal films, threads.

In various aspects, the conductive particles may be integrated or formed via a variety of methods and proportions. In one example, an IEM or similar device is embedded or otherwise mechanically associated with a “doughnut-shaped” powder and the hole formed therein is filled or otherwise associated with the conductive particles, to form the conductive region. The size, area, volume, locations or other parameters of the conductive regions may vary to the extent the functionality described herein may be carried out.

In certain aspects, a close proximity between the capacitive coupling device and IEM or similar device may facilitate or promote privacy aspects. In certain aspects, certain related devices may include, for example, a circuit with a Schottky diode in parallel with a CMOS transistor that is timed to be opened and closed, opened up. Other circuit designs and modifications are possible.

In certain aspects, the ingestible circuitry includes a coating layer. The purpose of this coating layer can vary, e.g., to protect the circuitry, the chip and/or the battery, or any components during processing, during storage, or even during ingestion. In such instances, a coating on top of the circuitry may be included. Also of interest are coatings that are designed to protect the ingestible circuitry during storage, but dissolve immediately during use. For example, coatings that dissolve upon contact with an aqueous fluid, e.g. stomach fluid, or the conducting fluid as referenced above. Also of interest are protective processing coatings that are employed to allow the use of processing steps that would otherwise damage certain components of the device. For example, in aspects where a chip with dissimilar material deposited on the top and bottom is produced, the product needs to be diced. The dicing process, however, can scratch off the dissimilar material, and also there might be liquid involved which would cause the dissimilar materials to discharge or dissolve. In such instances, a protective coating on the materials prevents mechanical or liquid contact with the component during processing can be employed. Another purpose of the dissolvable coatings may be to delay activation of the device. For example, the coating that sits on the dissimilar material and takes a certain period of time, e.g., five minutes, to dissolve upon contact with stomach fluid may be employed. The coating can also be an environmentally sensitive coating, e.g., a temperature or pH sensitive coating, or other chemically sensitive coating that provides for dissolution in a controlled fashion and allows one to activate the device when desired. Coatings that survive the stomach but dissolve in the intestine are also of interest, e.g., where one desires to delay activation until the device leaves the stomach. An example of such a coating is a polymer that is insoluble at low pH, but becomes soluble at a higher pH. Also of interest are pharmaceutical formulation protective coatings, e.g., a gel cap liquid protective coating that prevents the circuit from being activated by liquid of the gel cap. When optical wireless energy sources are provided, the coating may be optically transparent or an optically transparent aperture may be formed in the coating to allow optical radiation to reach the photodiode element of the wireless energy source.

Identifiers of interest include two dissimilar electrochemical materials, which act similar to the electrodes (e.g., anode and cathode) of a power source. The reference to an electrode or anode or cathode are used here merely as illustrative examples. The scope of the present disclosure is not limited by the label used and includes the aspect wherein the voltage potential is created between two dissimilar materials. Thus, when reference is made to an electrode, anode, or cathode it is intended as a reference to a voltage potential created between two dissimilar materials.

When the materials are exposed and come into contact with the body fluid, such as stomach acid or other types of fluid (either alone or in combination with a dried conductive medium precursor), a potential difference, that is, a voltage, is generated between the electrodes as a result of the respective oxidation and reduction reactions incurred to the two electrode materials. A voltaic cell, or battery, can thereby be produced. Accordingly, in aspects of the present disclosure, such power supplies are configured such that when the two dissimilar materials are exposed to the target site, e.g., the stomach, the digestive tract, a voltage is generated.

In certain aspects, one or both of the metals may be doped with a nonmetal, e.g., to enhance the voltage output of the battery. Non-metals that may be used as doping agents in certain aspects include, but are not limited to: sulfur, iodine and the like.

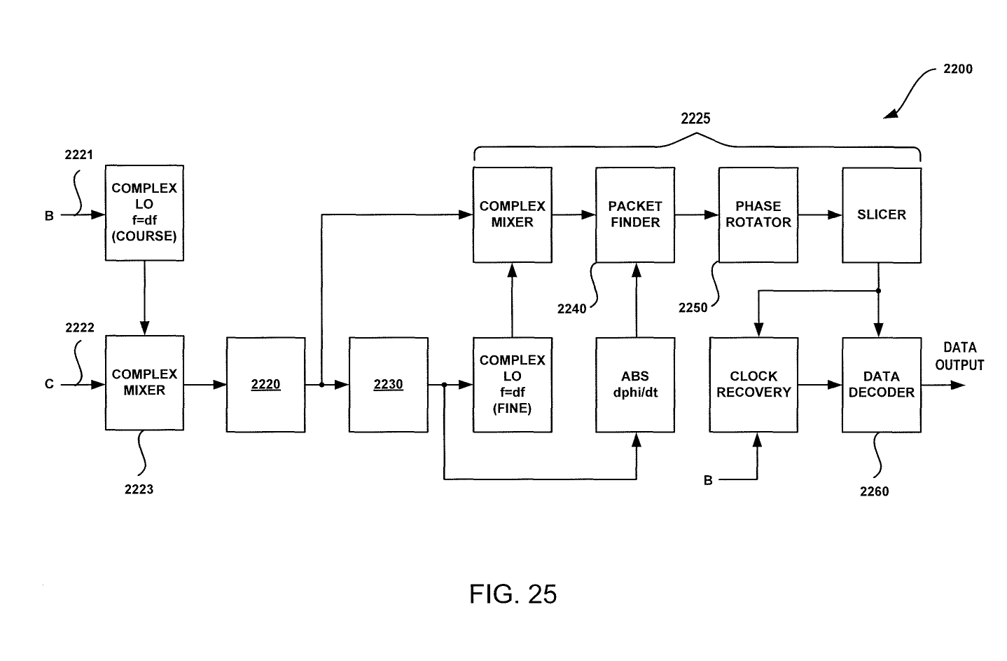

In addition, various enabling aspects of the receiver/detector are illustrated in FIGS. 25-30 below. FIG. 25 provides a functional block diagram of how a receiver may implement a coherent demodulation protocol, according to one aspect of the disclosure. It should be noted that only a portion of the receiver is shown in FIG. 25. FIG. 25 illustrates the process of mixing the signal down to baseband once the carrier frequency (and carrier signal mixed down to carrier offset) is determined. A carrier signal 2221 is mixed with a second carrier signal 2222 at mixer 2223. A narrow low-pass filter 2220 is applied of appropriate bandwidth to reduce the effect of out-of-bound noise. Demodulation occurs at functional blocks 2225 in accordance with the coherent demodulation scheme of the present disclosure. The unwrapped phase 2230 of the complex signal is determined. An optional third mixer stage, in which the phase evolution is used to estimate the frequency differential between the calculated and real carrier frequency can be applied. The structure of the packet is then leveraged to determine the beginning of the coding region of the BPSK signal at block 2240. Mainly, the presence of the sync header, which appears as an FM porch in the amplitude signal of the complex demodulated signal is used to determine the starting bounds of the packet. Once the starting point of the packet is determined the signal is rotated at block 2250 on the IQ plane and standard bit identification and eventually decoded at block 2260.

In addition to demodulation, the transbody communication module may include a forward error correction module, which module provides additional gain to combat interference from other unwanted signals and noise. Forward error correction functional modules of interest include those described in PCT Application Serial No. PCT/US2007/024225 published as WO/2008/063626; the disclosure of which is herein incorporated by reference. In some instances, the forward error correction module may employ any convenient protocol, such as Reed-Solomon, Golay, Hamming, BCH, and Turbo protocols to identify and correct (within bounds) decoding errors.

Receivers of the disclosure may further employ a beacon functionality module. In various aspects, the beacon switching module may employ one or more of the following: a beacon wakeup module, a beacon signal module, a wave/frequency module, a multiple frequency module, and a modulated signal module.

The beacon switching module may be associated with beacon communications, e.g., a beacon communication channel, a beacon protocol, etc. For the purpose of the present disclosure, beacons are typically signals sent either as part of a message or to augment a message (sometimes referred to herein as “beacon signals”). The beacons may have well-defined characteristics, such as frequency. Beacons may be detected readily in noisy environments and may be used for a trigger to a sniff circuit, such as described below.

In one aspect, the beacon switching module may comprise the beacon wakeup module, having wakeup functionality. Wakeup functionality generally comprises the functionality to operate in high power modes only during specific times, e.g., short periods for specific purposes, to receive a signal, etc. An important consideration on a receiver portion of a system is that it be of low power. This feature may be advantageous in an implanted receiver, to provide for both small size and to preserve a long-functioning electrical supply from a battery. The beacon switching module enables these advantages by having the receiver operate in a high power mode for very limited periods of time. Short duty cycles of this kind can provide optimal system size and energy draw features.

In practice, the receiver may “wake up” periodically, and at low energy consumption, to perform a “sniff function” via, for example, a sniff circuit. For the purpose of the present application, the term “sniff function” generally refers to a short, low-power function to determine if a transmitter is present. If a transmitter signal is detected by the sniff function, the device may transition to a higher power communication decode mode. If a transmitter signal is not present, the receiver may return, e.g., immediately return, to sleep mode. In this manner, energy is conserved during relatively long periods when a transmitter signal is not present, while high-power capabilities remain available for efficient decode mode operations during the relatively few periods when a transmit signal is present. Several modes, and combination thereof, may be available for operating the sniff circuit. By matching the needs of a particular system to the sniff circuit configuration, an optimized system may be achieved.

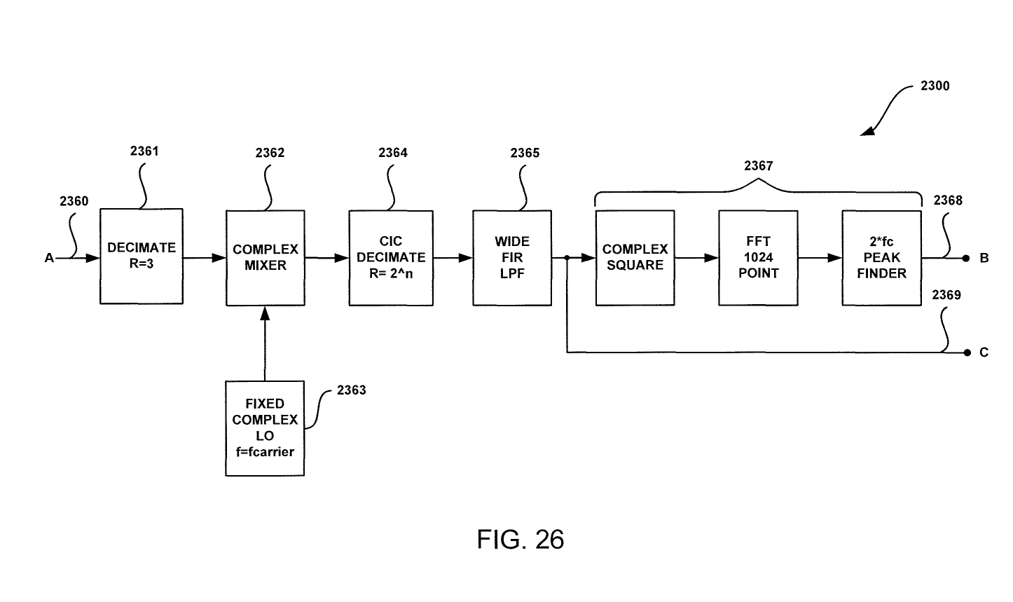

Another view of a beacon module is provided in the functional block diagram shown in FIG. 26. The scheme outlined in FIG. 26 outlines one technique for identifying a valid beacon. The incoming signal 2360 represents the signals received by electrodes, bandpass filtered (such as from 10 KHz to 34 KHz) by a high frequency signaling chain (which encompasses the carrier frequency), and converted from analog to digital. The signal 2360 is then decimated at block 2361 and mixed at the nominal drive frequency (such as, 12.5 KHz, 20 KHz, etc.) at mixer 2362. The resulting signal is decimated at block 2364 and low-pass filtered (such as 5 KHz BW) at block 2365 to produce the carrier signal mixed down to carrier offset—signal 2369. Signal 2369 is further processed by blocks 2367 (fast Fourier transform and then detection of two strongest peaks) to provide the true carrier frequency signal 2368. This protocol allows for accurate determination of the carrier frequency of the transmitted beacon.

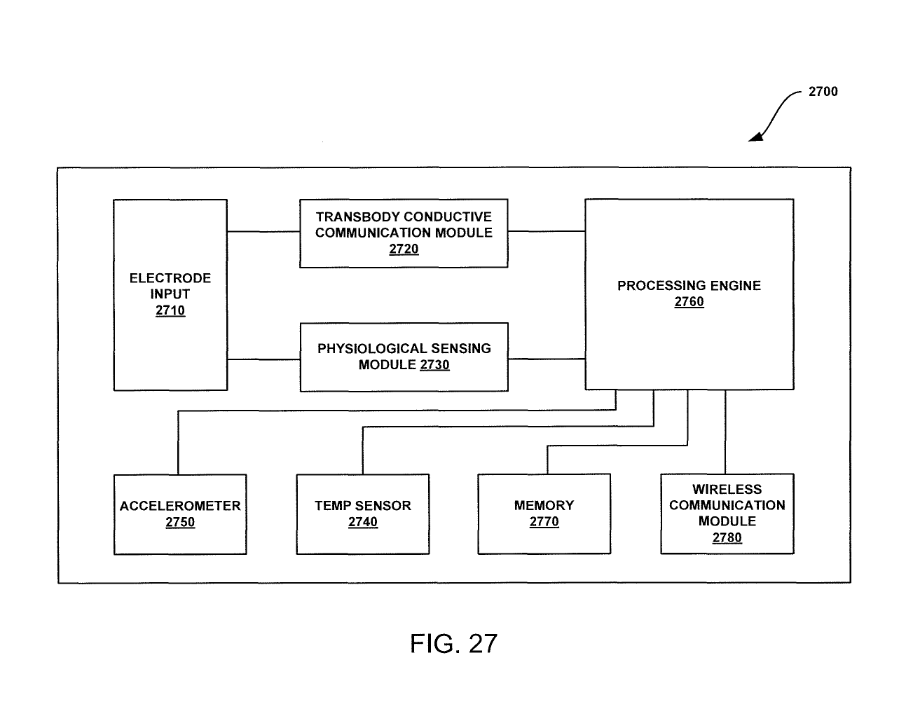

FIG. 27 provides a block functional diagram of an integrated circuit component of a signal receiver according to an aspect of the disclosure. In FIG. 27, a receiver 2700 includes electrode input 2710. Electrically coupled to the electrode input 2710 are transbody conductive communication module 2720 and physiological sensing module 2730. In one aspect, transbody conductive communication module 2720 is implemented as a high frequency (HF) signal chain and physiological sensing module 2730 is implemented as a low frequency (LF) signal chain. Also shown are CMOS temperature sensing module 2740 (for detecting ambient temperature) and a 3-axis accelerometer 2750. Receiver 2700 also includes a processing engine 2760 (for example, a microcontroller and digital signal processor), non-volatile memory 2770 (for data storage) and wireless communication module 2780 (for data transmission to another device, for example in a data upload action).

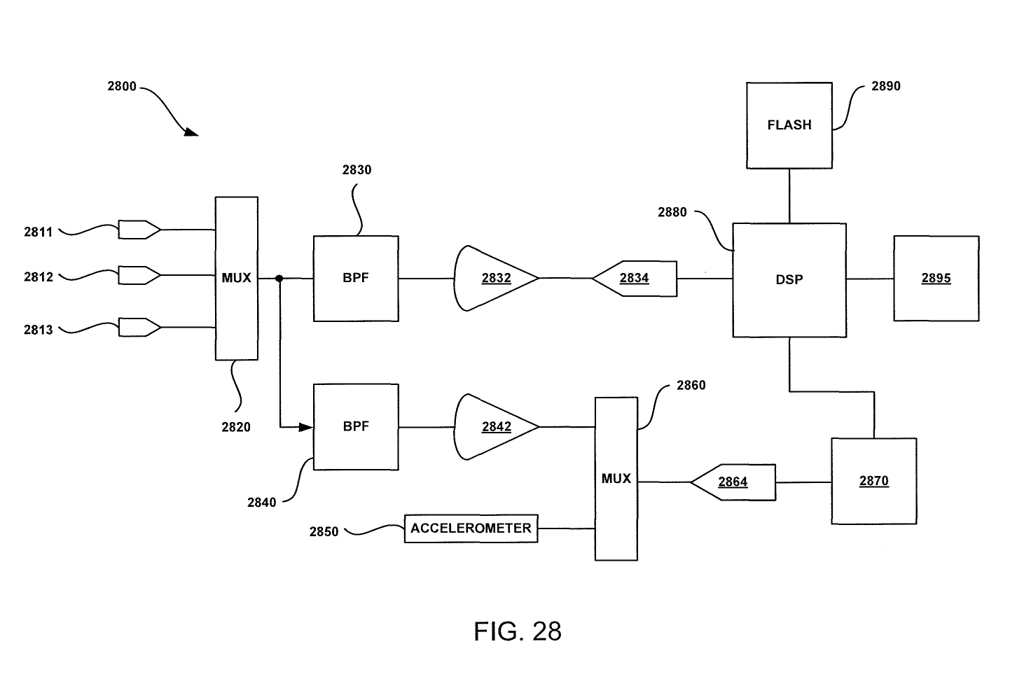

FIG. 28 provides a more detailed block diagram of a circuit configured to implement the block functional diagram of the receiver depicted in FIG. 27, according to one aspect of the disclosure. In FIG. 28, a receiver 2800 includes electrodes e1, e2 and e3 (2811, 2812 and 2813) which, for example, receive the conductively transmitted signals by an IEM and/or sense physiological parameters or biomarkers of interest. The signals received by the electrodes 2811, 2812, and 2813 are multiplexed by multiplexer 2820 which is electrically coupled to the electrodes.

Multiplexer 2820 is electrically coupled to both high band pass filter 2830 and low band pass filter 2840. The high and low frequency signal chains provide for programmable gain to cover the desired level or range. In this specific aspect, high band pass filter 2830 passes frequencies in the 10 KHz to 34 KHz band while filtering out noise from out-of-band frequencies. This high frequency band may vary, and may include, for example, a range of 3 KHz to 300 KHz. The passing frequencies are then amplified by amplifier 2832 before being converted into a digital signal by converter 2834 for input into high power processor 2880 (shown as a DSP) which is electrically coupled to the high frequency signal chain.

Low band pass filter 2840 is shown passing lower frequencies in the range of 0.5 Hz to 150 Hz while filtering out out-of-band frequencies. The frequency band may vary, and may include, for example, frequencies less than 300 Hz, such as less than 200 Hz, including less than 150 Hz. The passing frequency signals are amplified by amplifier 2842. Also shown is accelerometer 2850 electrically coupled to second multiplexer 2860. Multiplexer 2860 multiplexes the signals from the accelerometer with the amplified signals from amplifier 2842. The multiplexed signals are then converted to digital signals by converter 2864 which is also electrically coupled to low power processor 2870.

In one aspect, a digital accelerometer (such as one manufactured by Analog Devices), may be implemented in place of accelerometer 2850. Various advantages may be achieved by using a digital accelerometer. For example, because the signals the digital accelerometer would produce signals already in digital format, the digital accelerometer could bypass converter 2864 and electrically couple to the low power microcontroller 2870—in which case multiplexer 2860 would no longer be required. Also, the digital signal may be configured to turn itself on when detecting motion, further conserving power. In addition, continuous step counting may be implemented. The digital accelerometer may include a FIFO buffer to help control the flow of data sent to the low power processor 2870. For instance, data may be buffered in the FIFO until full, at which time the processor may be triggered to turn awaken from an idle state and receive the data.

Low power processor 2870 may be, for example, an MSP430 microcontroller from Texas Instruments. Low power processor 2870 of receiver 2800 maintains the idle state, which as stated earlier, requires minimal current draw—e.g., 10 μA or less, or 1 μA or less.

High power processor 2880 may be, for example, a VC5509 digital signal process from Texas Instruments. The high power processor 2880 performs the signal processing actions during the active state. These actions, as stated earlier, require larger amounts of current than the idle state—e.g., currents of 30 pA or more, such as 50 pA or more—and may include, for example, actions such as scanning for conductively transmitted signals, processing conductively transmitted signals when received, obtaining and/or processing physiological data, etc.

The receiver may include a hardware accelerator module to process data signals. The hardware accelerator module may be implemented instead of, for example, a DSP. Being a more specialized computation unit, it performs aspects of the signal processing algorithm with fewer transistors (less cost and power) compared to the more general purpose DSP. The blocks of hardware may be used to “accelerate” the performance of important specific function(s). Some architectures for hardware accelerators may be “programmable” via microcode or VLIW assembly. In the course of use, their functions may be accessed by calls to function libraries.

The hardware accelerator (HWA) module comprises an HWA input block to receive an input signal that is to be processed and instructions for processing the input signal; and, an HWA processing block to process the input signal according to the received instructions and to generate a resulting output signal. The resulting output signal may be transmitted as needed by an HWA output block.

Also shown in FIG. 28 is flash memory 2890 electrically coupled to high power processor 2880. In one aspect, flash memory 2890 may be electrically coupled to low power processor 2870, which may provide for better power efficiency.

Wireless communication element 2895 is shown electrically coupled to high power processor 2880 and may include, for example, a BLUETOOTH™ wireless communication transceiver. In one aspect, wireless communication element 2895 is electrically coupled to high power processor 2880. In another aspect, wireless communication element 2895 is electrically coupled to high power processor 2880 and low power processor 2870. Furthermore, wireless communication element 2895 may be implemented to have its own power supply so that it may be turned on and off independently from other components of the receiver—e.g., by a microprocessor.

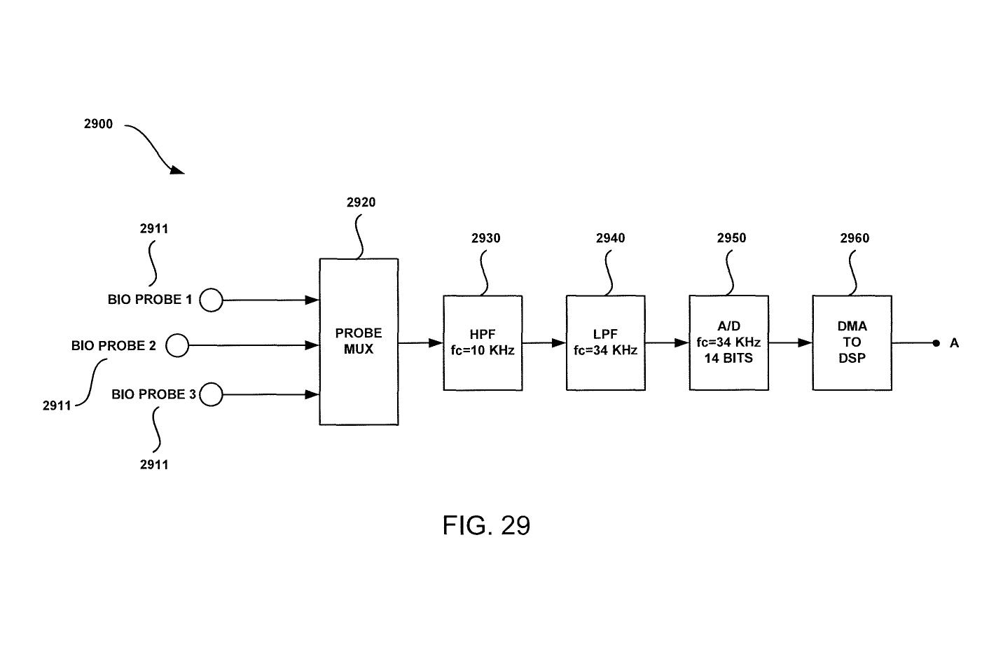

FIG. 29 provides a view of a block diagram of hardware in a receiver according to an aspect of the disclosure related to the high frequency signal chain. In FIG. 29, receiver 2900 includes receiver probes (for example in the form of electrodes 2911, 2912 and 2913) electrically coupled to multiplexer 2920. Also shown are high pass filter 2930 and low pass filter 2940 to provide for a band pass filter which eliminates any out-of-band frequencies. In the aspect shown, a band pass of 10 KHz to 34 KHz is provided to pass carrier signals falling within the frequency band. Example carrier frequencies may include, but are not limited to, 12.5 KHz and 20 KHz. One or more carriers may be present. In addition, the receiver 2900 includes analog to digital converter 2950—for example, sampling at 500 KHz. The digital signal can thereafter be processed by the DSP. Shown in this aspect is DMA to DSP unit 2960 which sends the digital signal to dedicated memory for the DSP. The direct memory access provides the benefit of allowing the rest of the DSP to remain in a low power mode.

As stated earlier, for each receiver state, the high power functional block may be cycled between active and inactive states accordingly. Also, for each receiver state, various receiver elements (such as circuit blocks, power domains within processor, etc.) of a receiver may be configured to independently cycle from on and off by the power supply module. Therefore, the receiver may have different configurations for each state to achieve power efficiency.

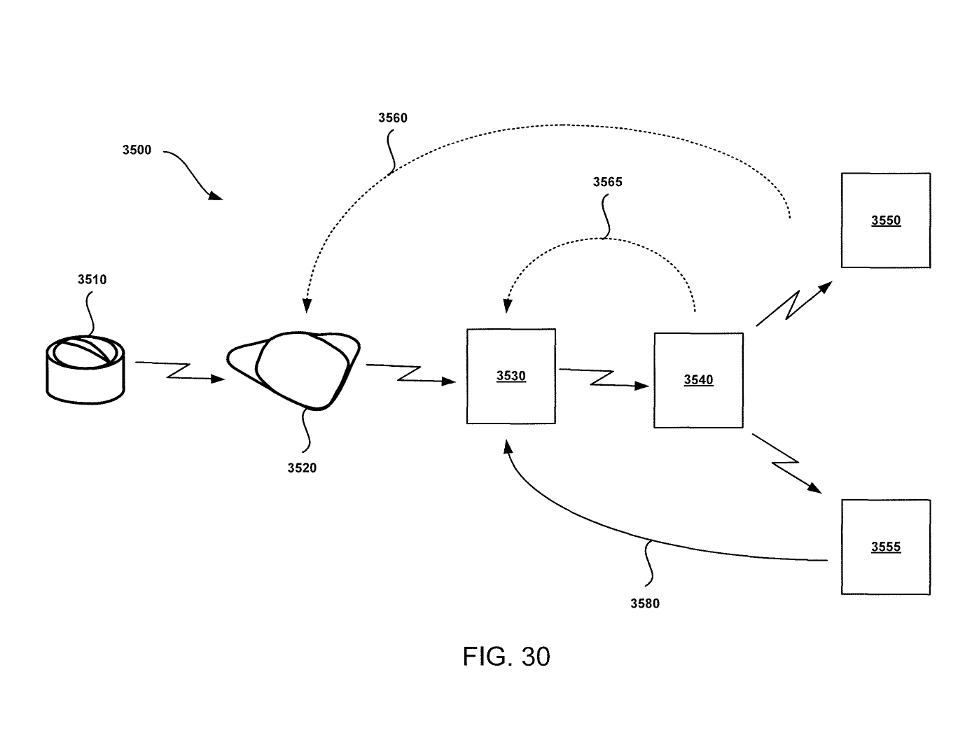

An example of a system of the disclosure is shown in FIG. 30. In FIG. 30, system 3500 includes a pharmaceutical composition 3510 that comprises an IEM. Also present in the system 3500 is signal receiver 3520. Signal receiver 3520 is configured to detect a signal emitted from the identifier of the IEM 3510. Signal receiver 3520 also includes physiologic sensing capability, such as ECG and movement sensing capability. Signal receiver 3520 is configured to transmit data to a patient's an external device or PDA 3530 (such as a smart phone or other wireless communication enabled device), which in turn transmits the data to a server 3540. Server 3540 may be configured as desired, e.g., to provide for patient directed permissions. For example, server 3540 may be configured to allow a family caregiver 3550 to participate in the patient's therapeutic regimen, e.g., via an interface (such as a web interface) that allows the family caregiver 3550 to monitor alerts and trends generated by the server 3540, and provide support back to the patient, as indicated by arrow 3560. The server 3540 may also be configured to provide responses directly to the patient, e.g., in the form of patient alerts, patient incentives, etc., as indicated by arrow 3565 which are relayed to the patient via PDA 3530. Server 3540 may also interact with a health care professional (e.g., RN, physician) 3555, which can use data processing algorithms to obtain measures of patient health and compliance, e.g., wellness index summaries, alerts, cross-patient benchmarks, etc., and provide informed clinical communication and support back to the patient, as indicated by arrow 3580.

It is to be understood that this disclosure is not limited to particular embodiments described, and as such may vary. It is also to be understood that the terminology used herein is for the purpose of describing particular embodiments only, and is not intended to be limiting, since the scope of the present disclosure will be limited only by the appended claims.

Notwithstanding the claims, the disclosure is also defined by the following clauses:
1. A system comprising:
   a control device; and
   a wireless energy source electrically coupled to the control device, the wireless energy source comprising an energy harvester to receive energy at an input thereof in one form and to convert the energy into a voltage potential difference to energize the control device.
2. The system of clause 1, wherein the energy harvester comprises one or more of the following:
   an optical energy conversion element to receive optical energy at the input of the energy harvester and to convert the optical energy into electrical energy,
   a vibration/motion energy conversion element to receive vibration/motion energy at the input of the energy harvester and to convert the vibration/motion energy into electrical energy,
   an acoustic energy conversion element to receive acoustic energy at the input of the energy harvester and to convert the acoustic energy into electrical energy,
   comprises a radio frequency energy conversion element to receive radio frequency energy at the input of the energy harvester and to convert the radio frequency energy into electrical energy,
   a thermal energy conversion element to receive radio thermal energy at the input of the energy harvester and to convert the thermal energy into electrical energy.
3. The system of clause 1 or 2, further comprising a power management circuit coupled to the energy harvester to convert the electrical energy from the energy harvester to the voltage potential difference suitable to energize the control device.
4. The system according to any of the preceding clauses further comprising an in-body device operative to communicate information to an external system located outside the body.
5. The system of clause 4, wherein the in-body device is operative to communicate information outside the body only when the wireless energy source is energized by an external energy source located outside the body.
6. The system according to any of the preceding clauses for altering conductance.
7. The system according to any of the preceding clauses further comprising
   a partial power source.
8. The system according to clause 7 wherein the partial power source comprises
   a first material electrically coupled to the control device; and
   a second material electrically coupled to the control device and electrically isolated from the first material.
9. The system according to clause 8
   wherein the first and second materials are selected to provide a second voltage potential difference when in contact with a conducting liquid.
10. The system according to clause 8 or 9 wherein the control device alters the conductance between the first and second materials such that the magnitude of the current flow is varied to encode information.
11. The system of any of the preceding clauses, wherein when the control device is energized by the wireless energy source and the control device alters the first voltage potential difference between the first and second materials such that a magnitude of the first voltage is varied to encode information.
12. The system according to any of the preceding clauses further comprising one or more of the following:
   a charge pump coupled to the energy harvester,
   a DC-DC converter coupled to the energy harvester,
   an AC-DC converter coupled to the energy harvester.
13. The system according to any of the preceding clauses further comprising
   a power source electrically coupled to the control device, the power source to
   provide a second voltage potential difference to the control device.
14. The system of clause 13, wherein the power source is one or more of the following:
   a thin film integrated battery,
   a supercapacitor,
   a thin film integrated rechargeable battery.
15. A system according to any of the preceding clauses which is ingestible.
16. System according to clause 15 further comprising a pharmaceutical product.
17. System according to any of the preceding clauses, which is activateable on coming into contact with a conducting body fluid.
18. System according to any of the preceding clauses further comprising a protective coating, which protective coating is dissolvable by body liquids and which coating can comprise conductive or non-conductive materials.
19. System according to any of the preceding clauses including a framework, upon which framework a first and a second digestible material is arranged, whereby upon contact with a bodily fluid a potential difference results between the two digestible materials, so that a current path is formed between the two digestible materials.
20. System according to clause 20 whereby the magnitude of the current is controllable by altering conductance between the first and second digestible materials.
21. System according to any of the preceding clauses further comprising current path extending means.
22. System according to any of the preceding clauses further comprising a pH sensor.
23. A pharmaceutical product supply chain management system comprising the system according to any of the preceding clauses.
24. A capacitive coupling device for testing a system according to any of the preceding clauses comprising a pharmaceutical product.
25. A method of testing a pharmaceutical product comprising the steps of associating the product with a system according to any of the clauses 1-23, and introducing the system into a capacitive coupling device.
26. Use of a system according to any of the preceding clauses 1-23 for indicating the occurrence of an event within the body.

1. A system comprising:
a control device; and
a wireless energy source electrically coupled to the control device, the wireless energy source comprising an energy harvester to receive energy at an input thereof in one form and to convert the energy into a voltage potential difference to energize the control device.

2. The system of claim 1, wherein the energy harvester comprises an optical energy conversion element to receive optical energy at the input of the energy harvester and to convert the optical energy into electrical energy.

3. The system of claim 1, wherein the energy harvester comprises a vibration/motion energy conversion element to receive vibration/motion energy at the input of the energy harvester and to convert the vibration/motion energy into electrical energy.

4. The system of claim 1, wherein the energy harvester comprises an acoustic energy conversion element to receive acoustic energy at the input of the energy harvester and to convert the acoustic energy into electrical energy.

5. The system of claim 1, wherein the energy harvester comprises a radio frequency energy conversion element to receive radio frequency energy at the input of the energy harvester and to convert the radio frequency energy into electrical energy.

6. The system of claim 1, wherein the energy harvester comprises a thermal energy conversion element to receive radio thermal energy at the input of the energy harvester and to convert the thermal energy into electrical energy.

7. The system of claim 1, further comprising a power management circuit coupled to the energy harvester to convert the electrical energy from the energy harvester to the voltage potential difference suitable to energize the control device.

8. The system of claim 1, further comprising an in-body device operative to communicate information to an external system located outside the body.

9. The system of claim 8, wherein the in-body device is operative to communicate the information outside the body only when the wireless energy source is energized by an external energy source located outside the body.

10. A system comprising:
a control device for altering conductance;
a wireless energy source electrically coupled to the control device, the wireless energy source comprising an energy harvester to receive energy at an input thereof in one form and to convert the energy into a first voltage potential difference to energize the control device; and
a partial power source comprising:
a first material electrically coupled to the control device; and
a second material electrically coupled to the control device and electrically isolated from the first material;
wherein the first and second materials are selected to provide a second voltage potential difference when in contact with a conducting liquid; and
wherein the control device alters conductance between the first and second materials such that a magnitude of a current flow is varied to encode information.

11. The system of claim 10, wherein when the control device is energized by the wireless energy source, the control device alters a first voltage potential difference between the first and second materials such that a magnitude of the first voltage potential is varied to encode information.

12. The system of claim 10, wherein the energy harvester comprises an optical energy conversion element to receive optical energy at the input of the energy harvester and to convert the optical energy into electrical energy.

13. The system of claim 10, further comprising a charge pump coupled to the energy harvester to convert the electrical energy from the energy harvester to the first voltage potential difference suitable to energize the control device.

14. The system of claim 10, further comprising a DC-DC converter coupled to the energy harvester to convert the electrical energy from the energy harvester to the first voltage potential difference suitable to energize the control device.

15. The system of claim 10, further comprising a AC-DC converter coupled to the energy harvester to convert the electrical energy from the energy harvester to the first voltage potential difference suitable to energize the control device.

16. A system comprising:
a control device;
a wireless energy source electrically coupled to the control device, the wireless energy source comprising an energy harvester to receive energy at an input thereof in one form and to convert the energy into a first voltage potential difference to energize the control device; and
a power source electrically coupled to the control device, the power source to provide a second voltage potential difference to the control device.

17. The system of claim 16, wherein the power source is a thin film integrated battery.

18. The system of claim 16, wherein the power source is a supercapacitor.

19. The system of claim 16, wherein the power source is a thin film integrated rechargeable battery.

20. The system of claim 16, further comprising a charge pump coupled to the energy harvester to convert the electrical energy from the energy harvester to the first voltage potential difference suitable to energize the control device.

21. The system of claim 16, further comprising a DC-DC converter coupled to the energy harvester to convert the electrical energy from the energy harvester to the first voltage potential difference suitable to energize the control device.

22. The system of claim 16, further comprising a AC-DC converter coupled to the energy harvester to convert the electrical energy from the energy harvester to the first voltage potential difference suitable to energize the control device.
